(19) United States
(12) Patent Application Publication
(10) Pub. No.: US 2009/0076670 A1
(43) Pub. Date: Mar. 19, 2009

(54) Olivo-Cerebellar Controller

(76) Inventors: Promode R. Bandyopadhyay, Middletown, RI (US); Sahjendra Singh, Henderson, NV (US)

Correspondence Address: NAVAL UNDERSEA WARFARE CENTER;DIVISION NEWPORT, 1176 HOWELL STREET, CODE 000C, NEWPORT, RI, 02841, US

(21) Appl. No.: 12/021,555

(22) Filed: Jan. 29, 2008

Related U.S. Application Data
(60) Provisional application No. 60/994,093, filed on Sep. 17, 2007.

(51) Int. Cl. B60K 31/00; G06F 17/11

(52) U.S. Cl. 701/21

(57) ABSTRACT

Non-linear control laws are disclosed and implemented with a controller and control system for maneuvering an underwater vehicle. The control laws change the phase of one Inferior-Olive (IO) neuron with respect to another IO. One control law is global, that is, the control law works (stable and convergent) for any initial condition. The remaining three control laws are local. The control laws are obtained by applying feedback linearization, while retaining non-linear characteristics. Each control law generates a profile (time history) of the control signal to produce a desired phase difference recognizable by a controller to respond to disturbances and to maneuver an underwater vehicle.

This application claims the benefit of U.S. Provisional Patent Application Ser. No. 60/994,093, filed on Sep. 17, 2007 and which is entitled “Olivo-Cerebellar Controller” by the inventors, Sahjendra Singh and Promode R. Bandyopadhyay.

### CROSS REFERENCE TO OTHER PATENT APPLICATIONS

This application relates to U.S. patent application Ser. No. 11/901,546, filed on Sep. 14, 2007 and which is entitled “Auto-catalytic Oscillators for Locomotion of Underwater Vehicles” by the inventors Promode R. Bandopadhyay, Alberto Menozzi, Daniel P. Thivierge, David Beal and Anuradha Annnaswamy.

### STATEMENT OF GOVERNMENT INTEREST

The invention described herein may be manufactured and used by or for the Government of the United States of America for governmental purposes without the payment of any royalties thereon or therefore.

### BACKGROUND OF THE INVENTION

(1) Field of the Invention

The present invention relates to a controller and control system for an underwater vehicle; specifically, a controller and control system which utilize non-linear dynamics supported by underlying mathematics to control the propulsors of an underwater vehicle.

(2) Description of the Prior Art

Future underwater platforms are expected to have numerous sensors and performance capabilities that will mimic the capabilities of aquatic animals. A key component of such platforms would be their controller. Because such platforms, and an existing U.S. Navy Biorobotic Autonomous Undersea Vehicle (BAUV) is an example, keep station in highly disturbed fields near submarines or in the littoral areas, it is essential for the platforms (vehicles) to have quick-responding controllers for their propulsor systems.

Hydrodynamic models based on conventional engineering controllers have not been able to produce the desired levels of control. Thus, a biology-inspired controller is a realistic alternative. Because the brains of animals perform complex tasks which rely on nonlinear dynamics, the underlying mathematics provide a foundation for the controller and control system of the present disclosure.

Traditional control systems are designed using linear models obtained by Jacobian linearization. This linearization allows design using frequency domain techniques (such as lag-lead compensation, PID feedback, etc.) and a state-space approach (linear optimal control, pole assignment, servo-regulation, adaptive control, etc.). However, any controller designed using linearized models of the system will fail to stabilize unless the perturbations are small.

One must use nonlinear design techniques if the control system is to operate in a larger region. For underwater vehicles, linear and nonlinear control systems based on pole placement, feedback linearization, sliding mode control, and adaptive control, etc. have been designed. However, in these designs, it is assumed that the vehicle is equipped with traditional control surfaces. As such, these vehicles have limited maneuvering capability.

For large and agile maneuvers, traditional control surfaces are inadequate and new control surfaces must be developed. Observations of marine animals provide the potential of fish-like oscillating fins for the propulsion and maneuvering of autonomous underwater vehicles (AUVs). AUVs exist with multiple oscillating fins which impart high lift and thrust. The oscillatory motion of the fins or propulsors is obtained by inferior olives which provide robust command signals to controllers and servomotors of the fins.

Inferior olives have complex nonlinear dynamics and have robust and unique self-oscillation [(Limit Cycle Oscillation (LCO)] characteristics. Efforts have been made to model the inferior olives (IO). Limited results on phase control of IOs in an open-loop sense are available using a pulse type stimulus. However, the required pulse height of the input signal which depends on the state of the IOs at the switching instant as well as the target relative phase between the IOs has not been derived. For the application of the IOs to the AUV, closed-loop control systems must be developed for the synchronization and phase control of the IOs.

### SUMMARY OF THE INVENTION

It is therefore a general purpose and primary object of the present invention to provide control laws for the synchronization and phase angle control of multiple inferior olives (IO) used in a maneuvering controller or control system of an underwater vehicle;

It is a further object of the present invention to provide non-linear control laws that the controller or control system can use to change a phase of one IO with respect to another IO; and

It is a still further object of the present invention to provide a global control law for a controller to use in maneuvering an underwater vehicle; and

It is a still further object of the present invention to provide a local control law for a controller to use in maneuvering an underwater vehicle.

In order to attain the objects described, the present invention provides closed-loop control of multiple inferior olives (IOs) for maneuvering a Biorobotic Autonomous Undersea Vehicle (BAUV). A model of an ith IO is described where variables are associated with sub-threshold oscillations and low threshold spiking. Higher threshold spiking is also described.

For the sake of simplicity, the synchronization of only two IOs is considered, but it is seen that the approach is extendable for the synchronization of any number of IOs.

In optimizing the controller or control system for maneuvering, the state vector for the ith IO is defined and a nonlinear vector function and constant column vector are obtained. Synchronization is defined by first considering the synchronization of two IOs having arbitrary and possibly large initial conditions. Note that if a delay time is zero, the IOs oscillate in synchronism with a relative phase zero. However, if one sets the delay time, the IO₁ will oscillate lagging behind the IO₂ with a relative phase angle. Although, the convergence of the synchronization error has been required to be only asymptotic; for practical purposes, it will be sufficient if one can design a control system for the IO₁ which is sufficiently fast.

In the disclosure, four control systems are presented for the synchronization of two IOs based on an input-output feedback linearization (nonlinear inversion) approach. For the purpose of the design of the controller or control system, output variables associated with the nonlinear system. It is shown that the choice of the output variable is important in shaping the behavior of the closed-loop system; although, by following the approach presented, various input-output linearizing control systems can be obtained.

The derivation of a control law is considered for the global synchronization of the IO₁ with the reference IO₂. It is desired to design a synchronizing control system such that IO₁ oscillates in synchronism with a delay time corresponding to a desired phase angle with respect to the reference IO₂. In global synchronization, the synchronization is accomplished for all values of initial conditions of the two IOs. The output function is a function of the state vectors of IO₁ and IO₂. This choice of the output yields the global result.

For the nonlinear closed-loop system, the output satisfies a fourth order linear differential equation. One can choose larger gains to obtain faster convergence to zero. For the chosen output, because the system is of dimension four and the relative degree is four, the dimension of the zero dynamics is null. The zero dynamics represent the residual dynamics of the system when the output error is constrained to be zero.

The frequency of oscillation of the IOs depends on the system parameters. Signals of different frequencies can be obtained by time scaling. In the disclosure it is observed that the IOs are not initially in phase. As the controller switches, the IOs synchronize. However, as the command changes, it causes larger deviations in the tracking of trajectories due to a large control input.

The controller or the control system uses feedback of nonlinear functions of state variables and has a global synchronization property. The complexity and performance of the controller depends on the choice of the output function.

The IOs will synchronize if the equilibrium point is asymptotically stable (globally asymptotically stable). For asymptotic analysis, ignoring a decaying part, which represents the deviation of a trajectory from, a periodic signal can be represented by a Fourier series. Moreover, the amplitude of the harmonic converges to zero and for stability analysis a finite number of harmonics will suffice.

A simple control law has linear feedback terms involving only \tilde{z} and \tilde{w} variables and are independent of uᵢ and vᵢ variables. The output \tilde{w} satisfies a first-order equation and in the closed-loop system \tilde{w} tends to zero. However, the stability in the closed-loop system will depend on the stability property of the zero dynamics. Apparently if the origin (ũ, \tilde{v}, \tilde{z})=0 of the zero dynamics is asymptotically stable, then \tilde{x} converges to zero as \tilde{w} tends to zero.

The relative merits of the four controllers are such that the first controller has a global stabilization property and the remaining controllers have established local synchronization. It is expected that as the complexity of control law increases, the region of stability enlarges. For this reason, one expects that the control law can accomplish synchronization for relatively small perturbations at the instant when the phase command is given. Of course, the error, and therefore the synchronization of the IOs, depends on the instant of controller switching. Based on simulation results, it has been found that two control laws for the controllers have fairly large regions of stability and one control law does not necessarily have to use another control law.

Unlike the global control laws for the controller, the local control laws provide smoother responses. This is due to a fast-varying nonlinear function of large magnitude in the control law. There exists flexibility in the design, and by a proper choice of feedback gains and the reference phase command signals, one can obtain different response characteristics. This flexibility in phase control of IOs is useful in performing desirable maneuvers for the BAUV.

One must note that the profile of the control signal will depend on the states of the IOs when a pulse is applied. The derived controllers are based on the input-output feedback linearization theory, as well as stability and convergence. The control system can be switched on for phase control at any instant since the system utilizes state variable feedback and one can command the IO to follow a sequence of phase change when needed.

### BRIEF DESCRIPTION OF THE DRAWINGS

Further objects and advantages of the invention will become readily apparent from the following detailed description and claims in conjunction with the accompanying drawings wherein;

FIG. 1A-1D are each a graph depicting global synchronization using control law Cᵤ with IO₁ commanded to track IO₂ with a delay 0.125 for t ε [0, 4), 0.25 for t ε [4, 6), 0.5 for t ε [6, 8) and 0.75 for t ε [8, 10) with the controller of IO₁, switching at two seconds, plots are of x₁(t) and x₂(t−t_{d});

FIG. 2A-2D are each a graph depicting global synchronization using control law, Cᵤ, plots are of x₂(t) and x₂(t−t_{d}) for command inputs of FIG. 1A-1D;

FIG. 3A-3D are each a graph depicting global synchronization using control law, Cᵤ, plots are of uᵢ (t), vᵢ(t), zᵢ (t) and control inputs Iₑₛₜ₁, Iₑₓₜ₂ for command inputs of FIG. 1A-1D;

FIG. 4A-4D are each a graph depicting local synchronization using control law Cᵥ with IO₁ commanded to track IO₂ with a delay 0.125 for t ε [0, 4), 0.25 for t ε [4, 6), 0.5 for t ε [6, 8) and 0.75 for t ε [8, 10) where the controller of IO₁ switches at two seconds, plots are of x₁(t) and x₂(t−t_{d});

FIG. 5A-5D are each a graph depicting local synchronization using control law, Cᵥ, plots of u₁ (t), v₁ (t), z₁ (t) and control inputs Iₑₓₜ₁, Iₑₓₜ₂ for the command inputs of FIG. 1A-FIG. 1D;

FIG. 6A is a graph depicting local synchronization using control law C_{z} with IO₁ commanded to track IO₂ with a delay 0.125 for t ε [0, 4), 0.25 for t ε [4, 6), 0.5 for t ε [6, 8), and 0.75 for t ε [8, 10) with the controller of IO₁ switching at two seconds, plots are of x₁(t) and x₂(t−t_{d});

FIG. 7A-7D are each a graph depicting local synchronization using control law, C_{z}, plots of u₁ (t), v₁ (t), z₁ (t) and control inputs Iₑₓₜ₁, Iₑₓₜ₂ for the command inputs of FIG. 1A-1D;

FIG. 8A-8D are each a graph depicting local synchronization using control law C_{w} with IO₁ commanded to track IO₂ with a delay 0.125 for t ε [0, 4), 0.25 for t ε [4, 6), t ε [6, 8) and 0.75 for t ε [8, 10) with the controller IO₁ switching at two seconds, plots are of x₁(t) and x₂(t−t_{d});

FIG. 9A-9D are each a graph depicting local synchronization using control law, C_{w}, plots of u₁(t), v₁(t), z₁(t) and control inputs Iₑₓₜ₁, Iₑₓₜ₂ for the command inputs of FIG. 1A-1D;

FIG. 10A-10D are each a graph depicting local synchronization using control law C_{w} (faster oscillation) with IO₁ commanded to track IO₂ with a delay 0.125 for t ε [0, 4), 0.25 for t ε [4, 6], 0.5 for t ε [6, 8) and 0.75 for t ε [8, 10) with the controller IO₁ switching at two seconds, plots are of x₁(t) and x₂(t−t_{d});

FIG. 11A-11D are each a graph depicting synchronization, plots are of x₂(t) and x₂(t−t_{d}) for the command inputs of FIG. 1A-1D; and

FIG. 12A-12D are each a graph depicting local synchronization using control law C_{W} (faster oscillation), plots are of u₁ (t) , v₁ (t), z₁ (t) and control inputs Iₑₓₜ₁, Iₑₓₜ₂ and control inputs for the command inputs of FIG. 1A-1D.

### DETAILED DESCRIPTION OF THE INVENTION

Referring now to the present disclosure, a subsection on inferior-olives and a practical application of control laws affecting inferior-olives are presented.

### Inferior Olives Model and Synchronization

This disclosure focuses on closed-loop control of multiple inferior olives (IOs) for maneuvering Biorobotic Autonomous Undersea Vehicles (BAUVs). The model of an ith IO is described by

$$[ \begin{matrix}{\dot{u}}_{i} \\ {\dot{v}}_{i} \\ {\dot{z}}_{i} \\ {\dot{w}}_{i}\end{matrix} ] = [ \begin{matrix}k {∈}_{Na}^{- 1} ( {p}_{iu} ( {u}_{i} ) - {v}_{i} ) \\ k ( {u}_{i} - {z}_{i} + {I}_{Ca} - {I}_{Na} ) \\ {p}_{iz} ( {z}_{i} ) - {w}_{i} \\ {∈}_{Ca} ( {z}_{i} - {I}_{Ca} )\end{matrix} ] + [ \begin{matrix}0 \\ 0 \\ 0 \\ - {∈}_{Ca}\end{matrix} ] {I}_{exit} ( t ) \qquad ( 1 )$$

where the variables “zᵢ” and “w”, are associated with the sub-threshold oscillations and low threshold (Ca-dependent) spiking, and “uᵢ” and “vᵢ” describe the higher threshold (Na⁺-dependent) spiking. The constant parameters ε_{Ca} and ε_{Na} control the oscillation time scale; I_{ca} and I_{Na} drive the depolarization levels; and k sets a relative time scale between the uv- and zw-subsystems.

The nonlinear functions are:

pᵢᵤ(uᵢ)=uᵢ(uᵢ−a)(1−uᵢ)

p_{iz}(zᵢ)=zᵢ(zᵢ−a)(1−zᵢ) (2)

“p” being a non-linear function and “a” is a constant parameter.

The function Iₑₓₜᵢ (t) is the extra-cellular stimulus which is used here for the purpose of control.

Define

xᵢ=(uᵢ,vᵢ,zᵢ,wᵢ)^{T}εR⁴ (3)

where “x” is the state vector of the ith IO, “R” is the set of real numbers. Equation (1) can be written in a compact form as

\dot{x}ᵢ=fᵢ(xᵢ)+gᵢu_{ci} (4)

where u_{ci}=Iₑₓₜᵢ is the control input of the ith IO and “f”, “g” are vectors. The nonlinear vector function fᵢ (xᵢ)εR⁴ and the constant column vector gᵢ are obtained from Equation (1). It is known to those skilled in the art that a system utilizing Equation (1) exhibits limit cycle oscillations. Using harmonic balancing, it is possible to predict the approximate magnitudes, frequency and phases of periodic solutions of the components of the system.

As stated, the primary objective is to develop control laws for the synchronization and phase angle control of multiple IOs for the purpose of BAUV control. For the sake of simplicity, the synchronization of only two IOs is considered, but it is seen that the approach is extendable for the synchronization of any number of IOs. Synchronization is defined first.

Consider two IOs

\dot{x}₁=f₁(x₁)+g₁u_{c1}

\dot{x}₂=f₂(x₂)+g₂u_{c2}. (5)

Suppose that the state vector x₂ of the second IO is treated as the reference signal.

Consider a solution x₂(t) of the IO₂ beginning from an initial condition x₂₀, with an input u_{c2}=0 set to zero and let x₂(t−t_{d}) [“t” being time] be the delayed signal obtained from x₂(t), where t_{d}>0 is an arbitrary delay time. Then for the prescribed delay time t_{d}, IO₁ is said to be asymptotically synchronized to the IO₂ if the error signal \tilde{x}(t)=x₁(t)−x₂(t−t_{d}) converges to zero as t tends to ∞ [infinity].

Consider the synchronization of the two IOs having arbitrary and possibly large initial conditions. Note that if the delay time is zero, x₁(t)−x₂(t) diminishes to zero as time progresses and the IOs oscillate in synchronism with a relative phase zero. However, if one sets the delay time as t_{d}=φ/(2πf) (“f” is the period of oscillation of the IO₂), the IO₁ will oscillate lagging behind the IO₂ with a relative phase angle φ. Although, the convergence of the synchronization error, has been required to be only asymptotic, for practical purposes, it will be sufficient if one can design the control system for the IO₁ which is sufficiently fast.

### Synchronizing Control Systems

Four control systems are presented for the synchronization of the two IOs based on an input-output feedback linearization (nonlinear inversion) approach. For the purpose of the design, consider output variables associated with the nonlinear system for Equation (5) of the form

e=h(x₁(t), x₂(t−t_{d})). (6)

Later “h”, which is a function of the state variables of the two IOs, is selected to meet the desired objective. It will be seen that the choice of the output variable “e” is important in shaping the behavior of the closed-loop system. Although, by following the approach presented here, various input-output linearizing control systems can be obtained, derivation of the four control systems of varying complexity and synchronizing characteristics are considered.

### Global Synchronization: Control Law (Cᵤ)

Now consider the derivation of a control law for the global synchronization of the IO₁ with the reference IO₂. The reference IO₂ has an input Iₑₓₜ₂=0. It is desired to design a synchronizing control system such that IO₁ oscillates in synchronism with a delay time of t_{d} seconds corresponding to a desired phase angle φ with respect to reference IO₂. By global synchronization, the synchronization must be accomplished for all values of initial conditions x _{iO} ε R⁴, i=1,2 of the two IOs.

For the purpose of design, the controlled output variable is chosen as:

e(t)=hᵤ(x₁(t), x₂(t−t_{d}))=u₁(t)−u₂(t−t_{d}). (7)

Note that the output function “e” is a function of only the first component of the state vectors of IO₁ and IO₂ at time t and t−t_{d}, respectively. But it will be seen later that this choice of the output “e” yields the global result. The subscript “u” of the function “h” denotes dependence on the variables “uᵢ”.

For compactness, define the composite state vector for the two IOs as xₐ(t)=(x₁(t)^{T}, x₂(t−t_{d})^{T} ε R⁸, where “T” denotes matrix transposition. Then from Equation (5), one has

$${\dot{x}}_{a} ( t ) = [ \begin{matrix}{\dot{x}}_{1} ( t ) \\ {\dot{x}}_{2} ( t - {t}_{d} )\end{matrix} ] = [ \begin{matrix}{f}_{1} ( {x}_{1} ( t ) ) \\ f ( {x}_{2} ( t - {t}_{d} ) )\end{matrix} ] + [ \begin{matrix}{g}_{1} \\ 0\end{matrix} ] {u}_{c 1} ( t ) \dot{=} f ( {x}_{a} ( t ) ) + {gu}_{c 1} ( t ) . \qquad ( 8 )$$

The state error (\tilde{x}=x₁(t)−x₂(t−t_{d})) dynamics and the associated output e can be written as

$$\dot{\tilde{x}} = {f}_{1} ( \tilde{x} ( t ) + {x}_{2} ( t - {t}_{d} ) ) - {f}_{2} ( {x}_{2} ( t - {t}_{d} ) ) + {g}_{1} {u}_{c 1} ( t ) \dot{=} {f}_{e} ( \tilde{x} ( t ) , t ) + {g}_{1} {u}_{c 1} ( t ) \\ e = {h}_{u} ( {x}_{a} ( t ) ) = {h}_{u} ( \tilde{x} ( t ) ) \qquad ( 9 )$$

where fₑ(\tilde{x},t)=f₁(\tilde{x}(t)+x₂(t−t_{d}))−f₂(x₂(t−t_{d})) is defined. Note that argument “t” has been used in “fₑ” to indicate dependence on the bounded and known delayed reference state vector of the unforced IO₂. Thus, the system of Equation (9) can be treated as a nonautonomous system of dimension four.

Define the Lie derivative of the function hᵤ along the vector field f as

$$\begin{matrix}{L}_{f} {h}_{u} ( {x}_{a} ( t ) ) = \frac{\partial h}{\partial {x}_{a}} f ( {x}_{a} ( t ) ) = \frac{\partial {h}_{u}}{\partial {x}_{1}} {f}_{1} ( {x}_{1} ( t ) ) + \frac{\partial {h}_{u}}{\partial {x}_{2}} {f}_{2} ( {x}_{2} ( t - {t}_{d} ) ) \\ and for k = 0 , 1 , 2 … ; and let {L}_{f}^{j} {h}_{u} ( {x}_{a} ) = {L}_{f} {L}_{f}^{j} ( {x}_{a} ( t ) ) and & ( 10 ) \\ {L}_{g} {L}_{f}^{k} {h}_{u} ( {x}_{a} ) = \frac{\partial {L}_{f}^{k} {h}_{u}}{\partial {x}_{a}} g . & ( 11 )\end{matrix}$$

For the system of Equation (8), computing the Lie derivatives, it is verified that for j=0,1,2,3, one has

$$\begin{matrix}{e}^{( j )} ( t ) = {L}_{f}^{j} {h}_{u} ( {x}_{a} ( t ) ) \\ and for j = 4 gives & ( 12 ) \\ {e}^{( j )} ( t ) = {L}_{f}^{j} h ( {x}_{a} ( t ) ) + {L}_{g} {L}_{f}^{j - 1} h ( {x}_{a} ( t ) ) {u}_{c 1} ( t ) \dot{=} {a}_{u 1} ( \tilde{x} , t ) + {b}_{u 1} {u}_{c 1} & ( 13 )\end{matrix}$$

where e^{(k)}=de^{k}/dt^{k} and one can show that bᵤ₁=k² ε_{Ca}/ε_{Na}. For the nonautonomous system of Equation (9), defining

$$\begin{matrix}{L}_{fe} ( . ) = \frac{\partial ( . )}{\partial t} + \frac{\partial ( . )}{\partial \tilde{x}} {f}_{e} ( t , \tilde{x} ) & ( 14 ) \\ {L}_{fe}^{j} {h}_{u} ( \tilde{x} , t ) = {L}_{f}^{j} {h}_{u} ( {x}_{a} ) , j = 0 , 1 , … , 4 \\ and {L}_{g 1} {L}_{fe}^{3} {h}_{u} ( \tilde{x} , t ) = {b}_{u 1} . & ( 15 )\end{matrix}$$

Since the control input appears in the fourth derivative of the output e for the first time for the system utilizing Equation (9), the output e is of the relative degree r=4.

In view of Equation (13), an input-output linearizing control law is selected as

$${\dot{u}}_{c 1} = {b}_{u 1}^{- 1} \text{(} - {a}_{u 1} - {\sum }_{j = 0}^{3} {p}_{j} {L}_{f}^{j} {h}_{u} ( {x}_{a} ( t ) ) \qquad ( 16 )$$

where pⱼ, j=0,1,3, are the constant feedback gains and “b” is a vector. Because e^{(j)}(t)=L_{f}^{j}hᵤ(xₐ(t)), substituting the control law of Equation (16) in Equation (13) gives an output equation of the form

e⁽⁴⁾+p₃e⁽³⁾+p₂e⁽²⁾+p₁ė+p₀e=0 (17)

For the nonlinear closed-loop system of Equations (9) and (16), the output e(t) satisfies a fourth order linear differential equation. The gains pⱼ are chosen such that Equation (17) is exponentially stable, and thereby e(t) and derivatives of e(t) converge to zero as t tends to infinity. Of course, one can choose larger gains to obtain faster convergence of e(t) to zero. For the chosen output, because the system of Equation (9) is of dimension four and the relative degree of e is four, the dimension of the zero dynamics is null. The zero dynamics represent the residual dynamics of the system when the output error e(t) is constrained to be zero.

In fact, there exists a diffeomorphism Pᵤ for t ε[0,∞) mapping R⁴ into R⁴ such that \tilde{x}=Pᵤ(ξ,t), where ξ=(e, ė, ë, e⁽³⁾)^{T} ε R⁴. One can find the map Pᵤ. First of all, one has ũ=e, where \tilde{x}=x₁(t)−x₂(t−t_{d})=(ũ,\tilde{v},\tilde{z},\tilde{w})^{T} is defined. Using Equation (12) one can show that

$$\tilde{x} = {P}_{u} ( ξ , t ) = [ \begin{matrix}e \\ {q}_{1} ( e , \dot{e} , t ) \\ {q}_{2} ( e , \dot{e} , \ddot{e} , t ) \\ {q}_{3} ( e , \dot{e} , \ddot{e} , {e}^{( 3 )} , t )\end{matrix} ] \qquad ( 18 )$$

where

q₁=−ε_{Na}k⁻¹ė+p₁ᵤ(e+u₂(t−t_{d}))−p₂ᵤ(u₂(t−t_{d})), q₂=−\dot{q}₁k⁻¹+e, and q₃=−\dot{q}₂+p_{1z}(\tilde{z}+z₂(t−t_{d}))−p_{2z}(z₂(t−t_{d})).

Note that the argument “t” in “qᵢ” and “Pᵤ” indicates dependence on the reference trajectory x₂(t−t_{d}) and derivatives of the reference trajectory. Furthermore, it can be verified that Pu (0,t)=0; that is, \tilde{x}=0 when e and derivatives of e vanish. Because Pᵤ is a diffeomorphism, Pᵤ(0,t)=0, and the linear system of Equation (17) is exponentially stable, global synchronization of the IOs is accomplished and the two IOs oscillate together but with the required relative phase. Note that the control stimulus, Iₑₓₜ₁, vanishes when the IOs capture the unique limit cycle; only the IO₁ falls behind by the delay time t_{d} (phase angle φ).

To examine the synchronizing capability of the control system, the closed-loop system including the IOs given in Equation (5) and the control law of Equation (16) is simulated. The parameters of the IOs selected are: E_{Na}=0.001, E_{Ca}=0.02, k=0.1, I_{Ca}=0.018, I_{Na}=−0.61, and a=0.015. One can use another set of parameters as well. The input to IO₂ is kept to zero. The feedback gains chosen are such that the poles of Equation (17) are at 25(−0.424±j 1.263) and 25(−6.26±j 0.4141). These poles have been selected to obtain good transient responses by observing the simulated responses, however one could choose other pole locations as well for synchronization. The initial conditions are x₁₀=(0.4, 0.6, 0.4, 0.5)^{T} and x₂₀=(0.2, 0.4, 0.2, 0.3)^{T}. Thus the initial condition of the IOs differs. The frequency of oscillation of the IOs depends on the system parameters. Signals of different frequencies can be obtained by time scaling. For illustration, a time scaling is introduced by multiplying the derivatives of the variables by a scaling factor of sixty.

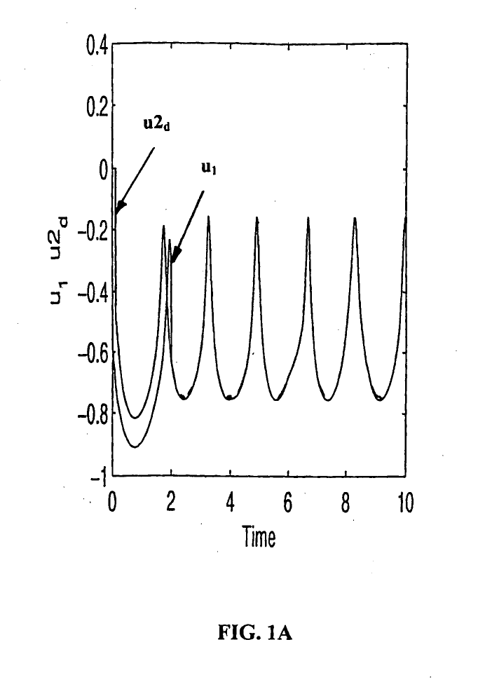

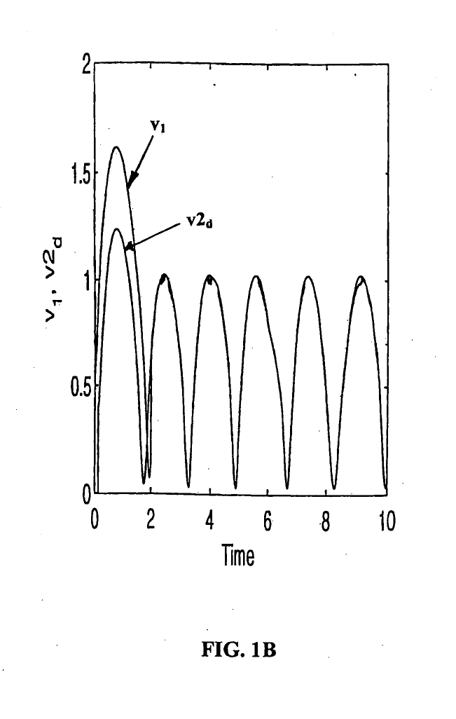

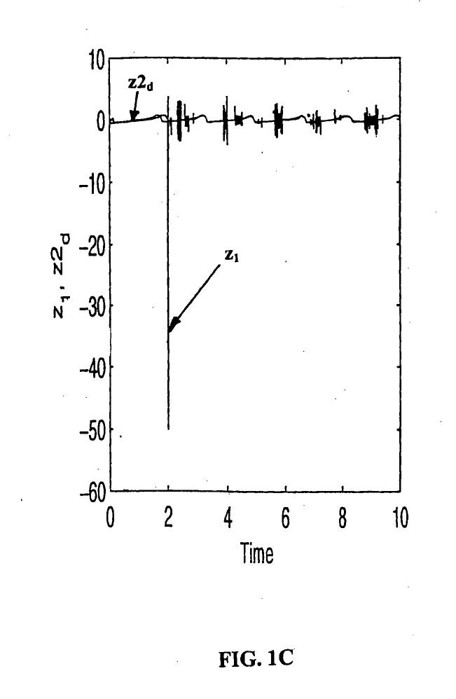

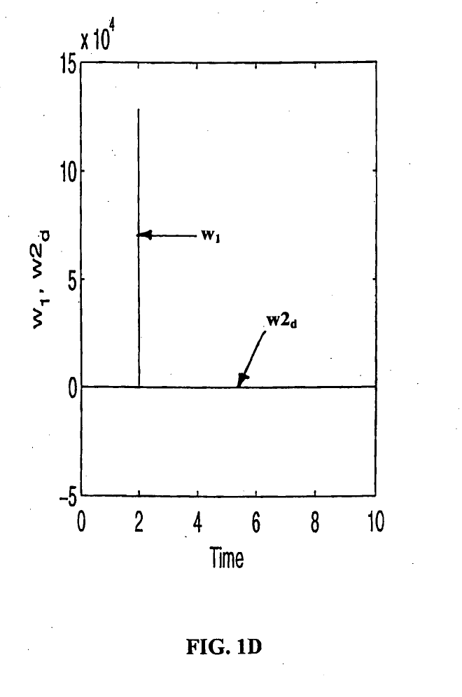

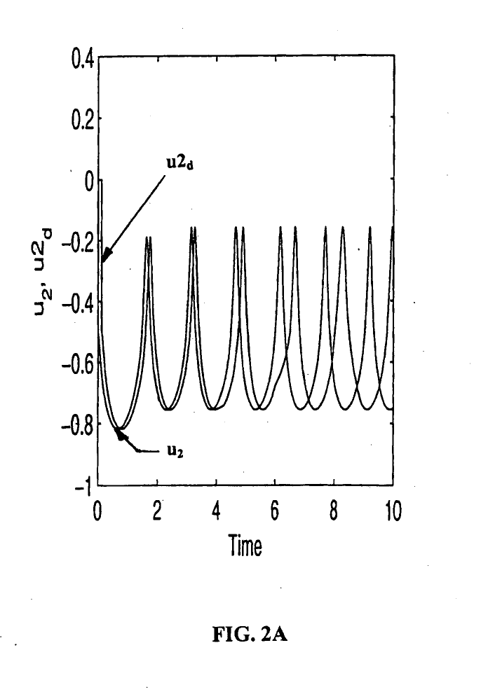

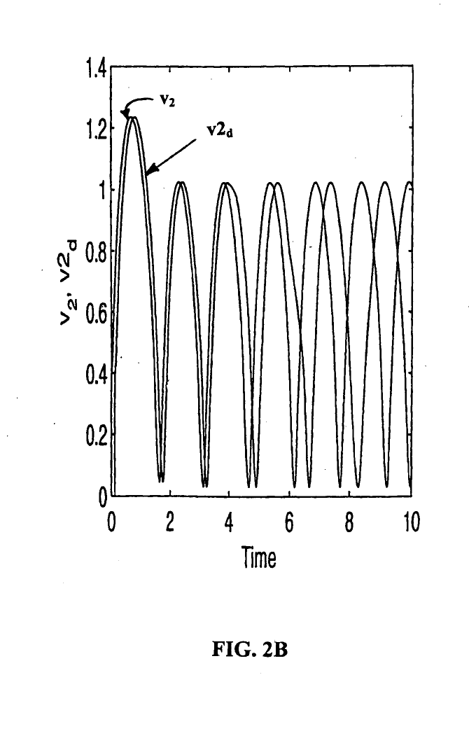

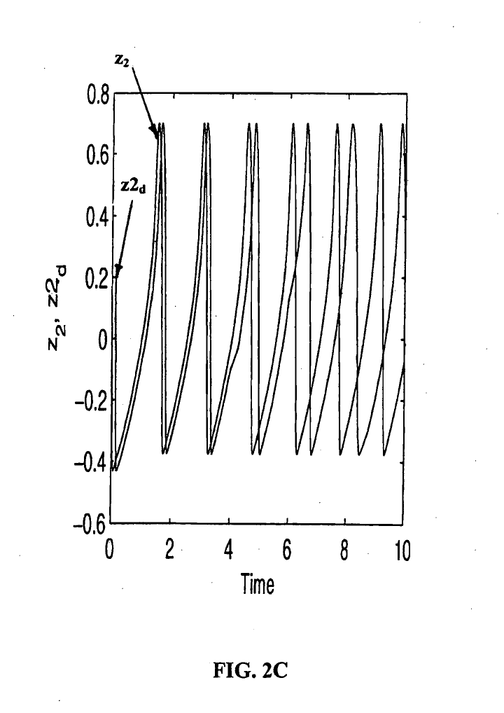

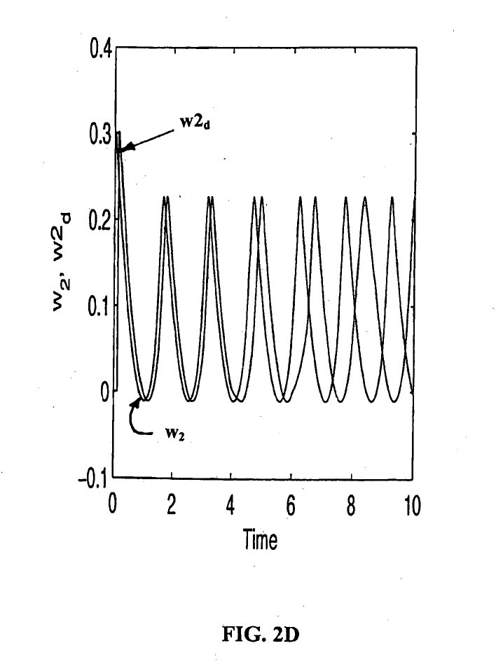

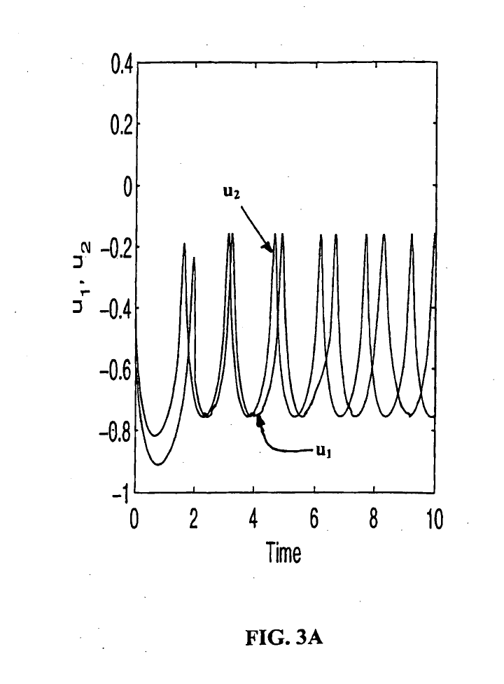

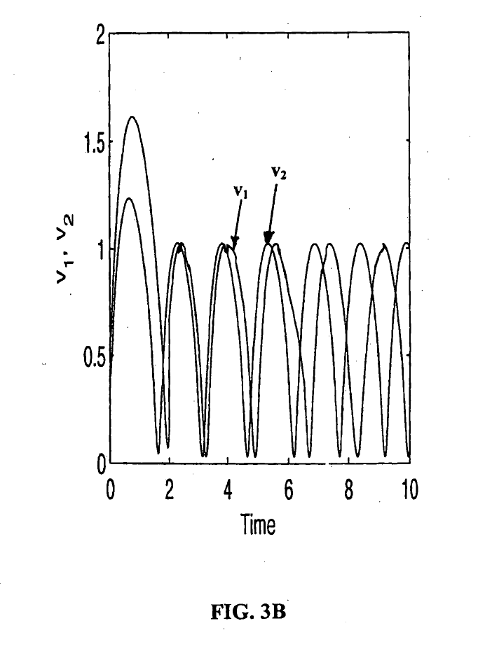

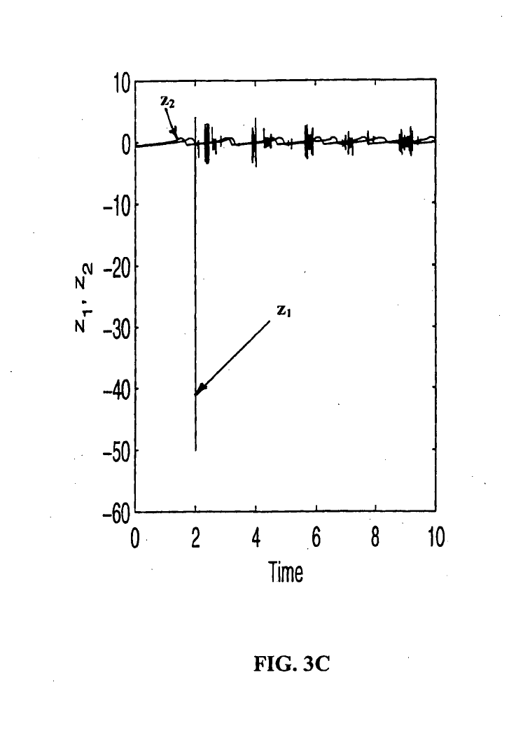

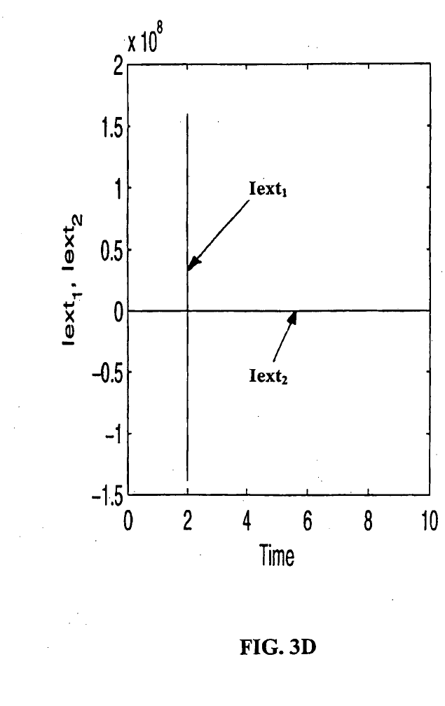

It is desired to have the delay time t_{d} as 0.125 for t ε [0,4), 0.25 for t ε [4, 6), 0.5 for t ε [6, 8) and 0.75 for t ε [8, 10), respectively. The controller is switched on at t=2 (sec), that is Iₑₓₜ₁=0 for t<2 and the delay command changes every two seconds. Referring now to the drawings, responses are shown in FIG. 1(a)-(d), FIG. 2(a)-(d) and FIG. 3(a)-(d). In the figures, the variables with a subscript “d” indicate delayed values (such as u2_{d} denoting u₂(t−t_{d})). It is observed that the IOs are not initially in phase. As the controller switches at two seconds, the IOs synchronize having a delay time of 0.125 seconds. The command changes at four, six, and eight seconds to delay times of 0.25, 0.5 and 0.75 seconds. Following each command, x₁(t) tracks x₂(t−t_{d}) and it is seen that u₁(t)−u₂(t−t_{d}) and v₁(t)−v₂(t−t_{d}) remain close to zero after two seconds. However, as the command changes, it causes larger deviations in the tracking of z- and w-trajectories due to large control input acting on the system. Note that a comparatively large spike appears in the control input at two seconds and subsequently smaller magnitudes of control input are required each time that the command changes. Simulation has been done for other initial conditions and a parameter value of a. It is found that frequency changes with a, but for a low value of a=0.01, u-response has a sharper spike.

The controller Cᵤ uses feedback of nonlinear functions of the state variables and has a global synchronization property. A controller using fewer state components and/or nonlinear feedback functions will be notable for implementation. The complexity and performance of the controller depends on the choice of the output function e. The existence of simpler controllers using different controlled output variables is examined in the next subsections.

### Local Synchronization: Control Law (Cᵥ)

Now consider the derivation of a control law (termed as Cᵥ) for the choice of controlled output variable

e(t)=hᵥ(xₐ(t))=v₁(t)−v₂(t−t_{d})=\tilde{v}(t). (19)

Note that the same symbol “e” is used to indicate a different function. For this choice of e, that for j=0, 1, 2, one has

$$\begin{matrix}{e}^{( j )} ( t ) = {L}_{f}^{j} {h}_{v} ( {x}_{a} ( t ) ) and for j = 3 gives & ( 20 ) \\ {e}^{( j )} ( t ) = {L}_{f}^{j} {h}_{v} ( {x}_{a} ( t ) ) + {L}_{g} {L}_{f}^{j - 1} {h}_{v} ( {x}_{a} ( t ) ) {u}_{c 1} ( t ) \dot{=} {a}_{v 1} ( \tilde{x} , t ) + {b}_{v 1} {u}_{c 1} & ( 21 )\end{matrix}$$

where one can show that bᵥ₁=−k ε_{Ca}. Since the control input appears in the third derivative of the output e for the first time for the system of Equation (9), the output e has the relative degree r=3.

In view of Equation (21), an input-output linearizing control law is selected as

$${u}_{c 1} = {b}_{v 1}^{- 1} ( - {a}_{v 1} - {\sum }_{j = 0}^{2} {p}_{j} {L}_{f}^{j} {h}_{v} ( {x}_{a} ( t ) ) ) \qquad ( 22 )$$

where pⱼ, j=0, 1, 2, are the constant feedback gains. Substituting the control law of Equation (22) in Equation (21) gives the output equation of the form

e⁽³⁾+p₂e^{(2)i +p}₁ė+p₀e=0. (23)

The gains p₁ are chosen such that the characteristic polynomial

Πᵥ(λ)=λ³+p₂λ²+p₁λ+p₀. (24)

associated with Equation (23) is Hurwitz, commonly known in the art. Hurwitz means that the roots of Πᵥ(λ)=0 have real part negative. For the choice of such parameters, e and the derivatives tend to zero.

For the nonlinear closed-loop system of Equation (9) and Equation (22), the output e(t) satisfies a third-order linear differential equation. Because the system of Equation (9) is of dimension four and the relative degree or e is three, the dimension of the zero dynamics is one. In fact, there exists a diffeomorphism Pᵥ for tε[0,∞) mapping R⁴ into R⁴ such that \tilde{x}=Pᵥ(ξ,t) where ξ is now defined as ξ=(ũ,e,ė,ë)^{T}. Using Equation (20) one can show that

$$\begin{matrix} \tilde{x} = {P}_{v} ( ξ , t ) = [ \begin{matrix}\tilde{u} \\ e \\ \tilde{u} - {k}^{- 1} \dot{e} \\ {q}_{v} ( \tilde{u} , e , \dot{e} , \ddot{e} , t )\end{matrix} ] \\ where & ( 25 ) \\ {q}_{v} = k {∈}_{Na}^{- 1} ( - {p}_{1 u} ( \tilde{u} + {u}_{2} ( t - {t}_{d} ) ) + {p}_{2 u} ( {u}_{2} ( t - {t}_{d} ) ) + e ) + {p}_{1 z} ( \tilde{z} + {z}_{2} ( t - {t}_{d} ) ) - {p}_{2 z} ( {z}_{2} ( t - {t}_{d} ) ) + {k}^{- 1} \ddot{e} & ( 26 )\end{matrix}$$

and it is understood that \tilde{z} is replaced by ũ−ė/k in qᵥ. Furthermore, it can be verified that Pᵥ(0, t)=0. However, the convergence of the error “e” and the derivative to zero does not necessarily imply the convergence of \tilde{x} to the origin. For the synchronization of the IOs, the stability property of the residual dynamics (the zero dynamics) must be examined when e vanishes.

It can be shown that the zero dynamics (when e=0) is given by

$$\dot{\tilde{u}} = - ka {∈}_{Na}^{- 1} \tilde{u} + k {∈}_{Na}^{- 1} [ ( 1 + a - 3 {u}_{2} ( t - {t}_{d} ) ) {\tilde{u}}^{2} + ( 2 ( 1 + a ) {u}_{2} ( t - {t}_{d} ) - 3 {u}_{2}^{2} ( t - {t}_{d} ) ) \tilde{u} - {\tilde{u}}^{3} ] \dot{=} {g}_{c} ( \tilde{u} , {u}_{2} ( t - {t}_{d} ) ) \qquad ( 27 )$$

The IOs will synchronize in a local (global) sense only if the equilibrium point ũ=0 is asymptotically stable (globally asymptotically stable). The system of Equation (27) is a nonlinear nonautonomous system and depends on the state u₂(t−t_{d}) of the reference IO. It is seen that the solution of Equation (27) is bounded, because for large ũ, g_{c} is dominated by −ũ³.

For the stability analysis, consider the solutions of the zero dynamics in a sufficiently small open set Ωᵤ around ũ=0. If u₂(t−t_{d}) is sufficiently small, one has (∂g_{c}(0,t)/∂ũ)<0, and therefore ũ=0 of the zero dynamics is exponentially stable and the controller accomplishes local synchronization.

Alternatively, one can establish asymptotic stability of the zero dynamics using a center manifold theorem known to those ordinarily skilled in the art. First note that, the solution x₂(t−t_{d}) of the reference IO converges to a closed orbit Γ₂. For asymptotic analysis, ignoring the decaying part, which represents the deviation of the trajectory from Γ₂, the periodic signal u₂(t−t_{d}) can be represented by a Fourier series. Moreover, the amplitude of the kth harmonic converges to zero as k tends to infinity and for stability analysis a finite number (N, a sufficiently large integer) of harmonics will suffice. Let ωₑ be the fundamental frequency of oscillation of the reference IO. As such, in the steady-state, it can be assumed that u₂(t−t_{d}) can be generated by an exosystem

\dot{x}ₑ=Λxₑ (28)

and u₂(t−t_{d})=C₀xₑ for row vector C_{O}, where the block diagonal matrix Λ is

$$Λ = diag \{ 0 , [ \begin{matrix}0 & - n {ω}_{e} \\ n {ω}_{e} & 0\end{matrix} ] , n = 0 , 1 , 2 , … N \} . \qquad ( 29 )$$

Assume that xₑ ε Ωₓₑ and that the set Ωₓₑ is sufficiently small. This implies that u₂(t−t_{d}) is small. Since Equation (27) is a function of xₑ and Equation (27) is stable, there exists an invariant manifold ũ(t)=Ũ(xₑ) which satisfies the partial differential equation

$$\frac{\partial \tilde{U}}{\partial {x}_{e}} Λ {x}_{e} = {g}_{c} ( \tilde{U} ( {x}_{e} ) , {x}_{e} ) . \qquad ( 30 )$$

In view of the form of the function g_{c}(ũ,u₂(t−t_{d})), Equation (30) has a trivial solution Ũ=0, and moreover for small initial conditions ũ(0), the solution of Equation (27) satisfies

∥ũ(t)−Ũ∥≦δₑ^{-μt}∥ũ(0)−Ũ∥ (31)

where “δ” and “μ” are positive numbers. Since Ũ=0, according to Equation (31), it follows that for small u (t−t_{d}), ũ converges exponentially to zero and this establishes local synchronization of the IOs because P_{V} is diffeomorphic. However, only local synchronization of the IOs is established using the control law of Equation (22).

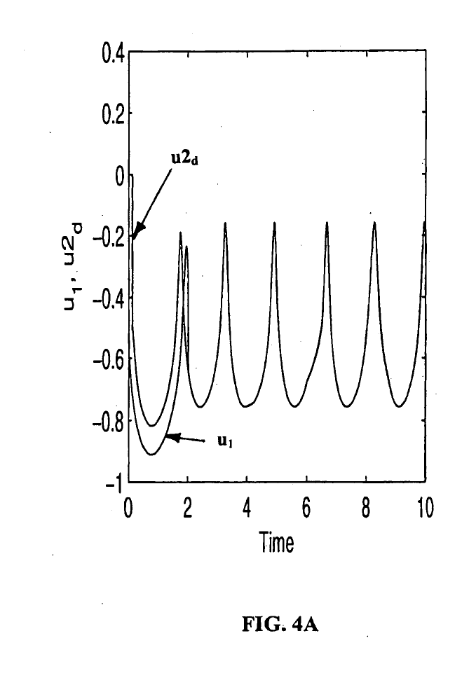

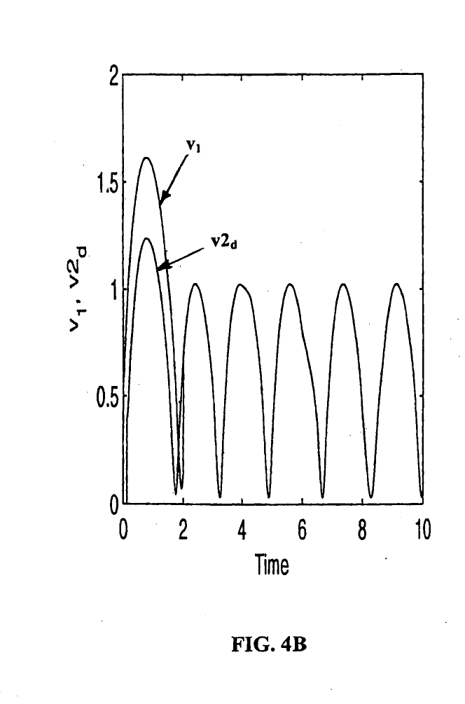

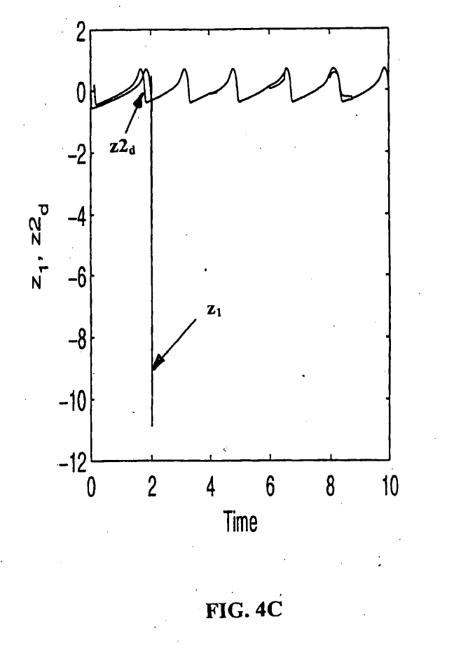

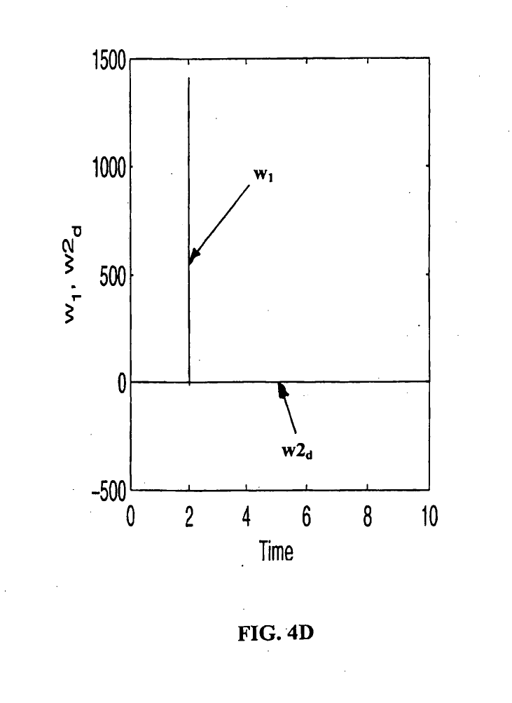

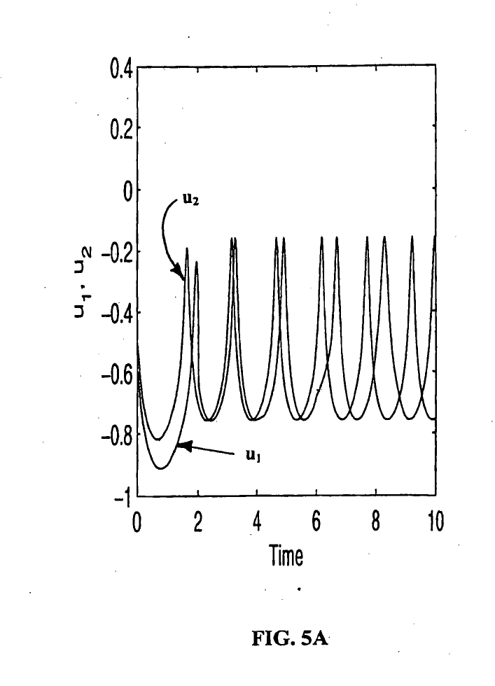

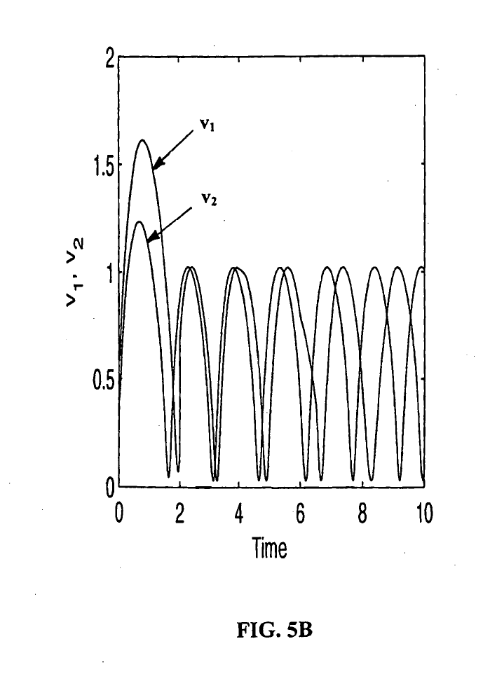

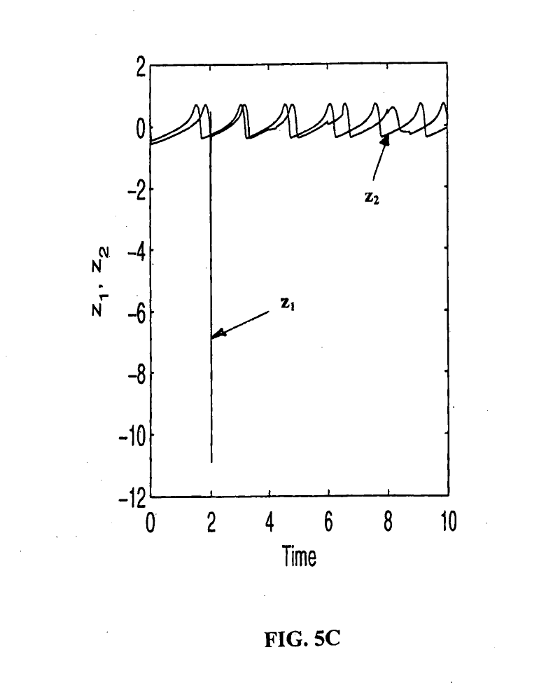

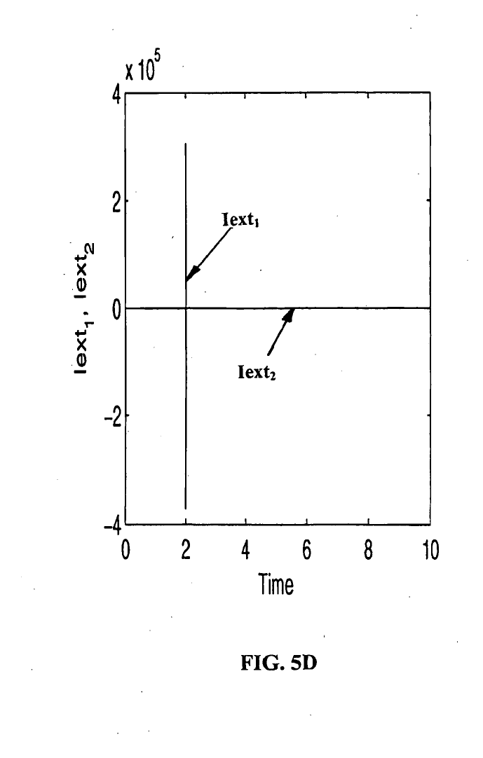

The closed-loop system including the control law of Equation (22) is simulated. The initial conditions, phase command signals and the model parameters of FIG. 1(A)-(D) are retained. The feedback parameters pᵢ now correspond to the poles −3.5405 and −5(0.521±j1.0681) of the polynomial Πᵥ(λ). Simulated responses are shown in FIG. 4(A)-(D) and FIG. 5(A)-(D). Observe that the IOs synchronize following each phase command. The control magnitude is smaller [see FIG. 3(A)-(D)] since the gains chosen are relatively small in this case. Although, it is not easy to establish global stability, it has been found by simulation that synchronization is accomplished for larger values of the initial conditions and different phase command sequences.

### Local Synchronization: Control Law (C_{z})

Consider the derivation of a control law based on

e(t)=z₁(t)−z₂(t−t_{d})=h_{z}(xₐ) (32)

as the controlled output. For this choice of “e” it is easily verified that for j=0,1, one has

$$\begin{matrix}{e}^{( j )} ( t ) = {L}_{f}^{i} {h}_{z} ( {x}_{a} ( t ) ) \\ and for j = 2 gives & ( 33 ) \\ {e}^{( j )} ( t ) = {L}_{f}^{i} {h}_{z} ( {x}_{a} ( t ) ) + {L}_{g} {L}_{f}^{j - 1} {h}_{z} ( {x}_{a} ( t ) ) {u}_{c 1} \dot{=} {a}_{z 1} ( \tilde{x} , t ) + {b}_{z 1} {u}_{c 1} & ( 34 )\end{matrix}$$

where one can show that b_{z1}=ε_{Ca}. Since the control input appears in the second derivative of the output e for the first time for the system of Equation (9), the output e has the relative degree r=2.

In view of Equation (34), an input-output linearizing control law is selected as

$${u}_{c 1} = {b}_{z 1}^{- 1} \text{(} - {a}_{z 1} - {\sum }_{j = 0}^{1} {p}_{j} {L}_{f}^{j} {h}_{v} ( {x}_{a} ( t ) ) \qquad ( 35 )$$

where pⱼ, j=0,1, are the constant feedback gains. Substituting the control law of Equation (35) in Equation (34) gives the output equation of the form

e⁽²⁾+p₁ė+p₀e=0. (36)

The gains pᵢ are chosen such that the characteristic polynomial

Π_{z}(λ)=λ²+p₁λ+p₀ (37)

associated with Equation (36) is Hurwitz.

The zero dynamics in this case are described by the Equations

$$\begin{matrix} [ \begin{matrix}\dot{\tilde{u}} \\ \dot{\tilde{v}}\end{matrix} ] = [ \begin{matrix}- ak {∈}_{Na}^{- 1} & - k {∈}_{Na}^{- 1} \\ k & 0\end{matrix} ] [ \begin{matrix}\tilde{u} \\ \tilde{v}\end{matrix} ] + [ \begin{matrix}{g}_{u} \\ 0\end{matrix} ] \\ where & ( 38 ) \\ {g}_{u} = k {∈}_{Na}^{- 1} [ ( 1 + a - 3 {u}_{2} ( t - {t}_{d} ) ) {\tilde{u}}^{2} + ( 2 ( 1 + a ) {u}_{2} ( t - {t}_{d} ) - 3 {u}_{2}^{2} ( t - {t}_{d} ) ) \tilde{u} - {\tilde{u}}^{3} ] & ( 39 )\end{matrix}$$

and a diffeomorphism p_{z}(ξ,t) exists such that \tilde{x}=P_{z}(ξ,t) where now ξ=(ũ,\tilde{v},e,ė)^{T}, and

$$\tilde{x} = {P}_{z} ( ξ , t ) = [ \begin{matrix}\tilde{u} \\ \tilde{v} \\ e \\ - \dot{e} + {p}_{1 z} ( e + {z}_{2} ( t - {t}_{d} ) ) - {p}_{2 z} ( {z}_{2} ( t - {t}_{d} ) )\end{matrix} ] \qquad ( 40 )$$

It follows that if the origin (ũ,\tilde{v})=0 of the zero dynamics is asymptotically stable and (e,ė)→0, then ξ tends to zero which implies the convergence of \tilde{x} to zero.

For the parameters of the IO, the matrix

$${A}_{z} = [ \begin{matrix}- ak {∈}_{Na}^{- 1} & - k {∈}_{Na}^{- 1} \\ k & 0\end{matrix} ] \qquad ( 41 )$$

is Hurwitz (i.e., the eigenvalues have a negative real part). In the steady state, gᵤ is a function of xₑ, the state of the exosystem of Equation (28). In this case, in view of the center manifold theorem, for xₑ ε Ωₓₑ, there exists an invariant manifold (ũ, \tilde{v})=(Ũ(xₑ), \tilde{V}(xₑ)) which satisfies the set of partial differential equations

$$\frac{\partial \tilde{U}}{\partial {x}_{e}} Λ {x}_{e} = - ak {∈}_{Na}^{- 1} \tilde{U} ( {x}_{e} ) - k {∈}_{Na}^{- 1} \tilde{V} ( {x}_{e} ) + {g}_{u} ( \tilde{U} ( {x}_{e} ) , {x}_{e} ) \\ \frac{\partial \tilde{V}}{\partial {x}_{e}} Λ {x}_{e} = k \tilde{U} ( {x}_{e} ) \qquad ( 42 )$$

These equations are satisfied by (Ũ(xₑ), \tilde{V}(xₑ))=0.

Similar to the arguments based on either the Jacobian linearization or the center manifold theorem, it can be concluded that for small u₂(t−t_{d}), the origin of the zero dynamics is exponentially stable (in a local sense), and thereby local synchronization is accomplished. Note that this control law is simpler that Cᵥ.

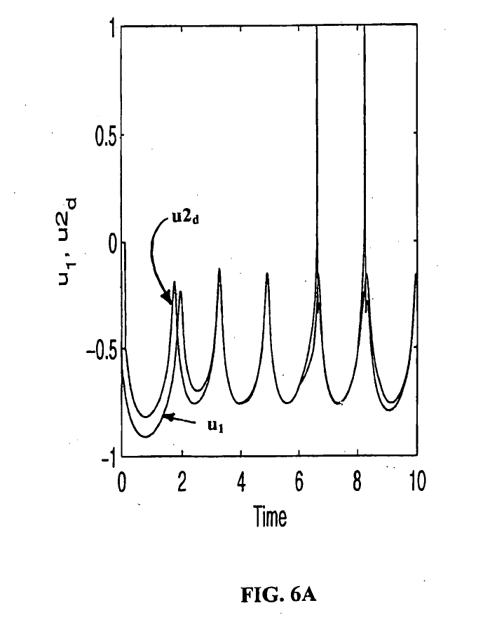

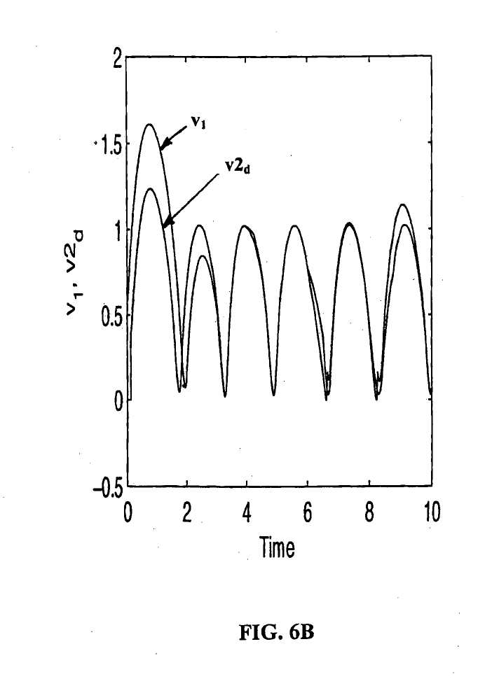

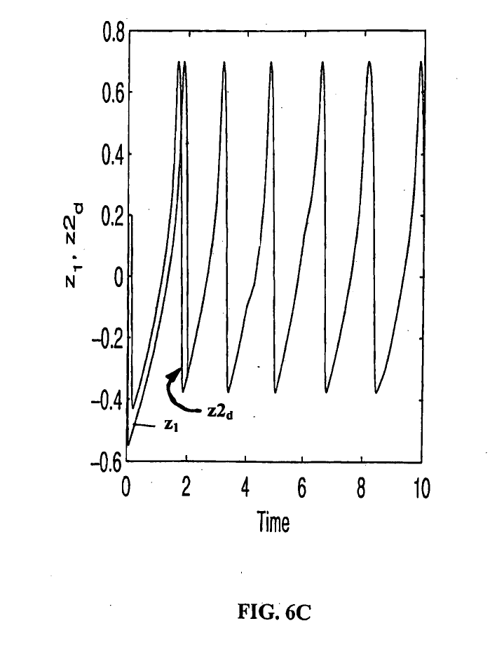

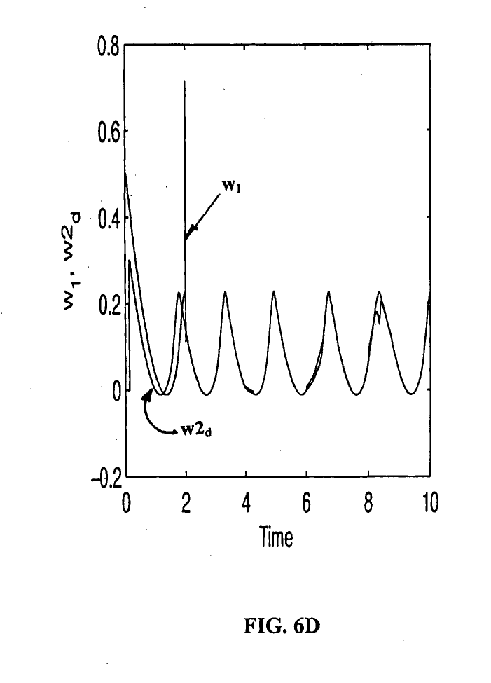

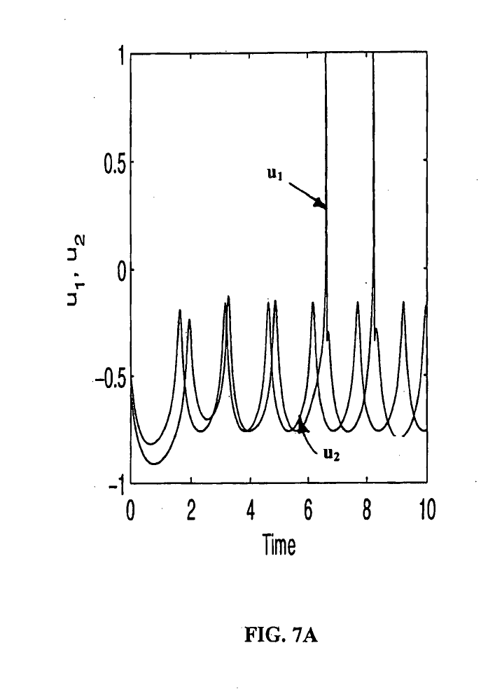

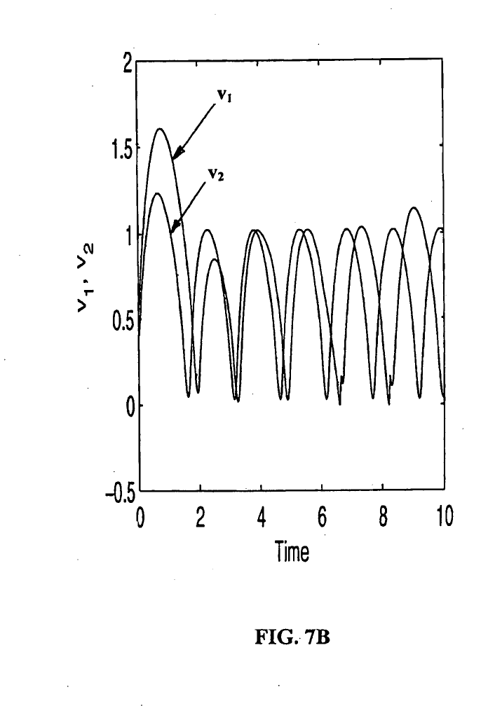

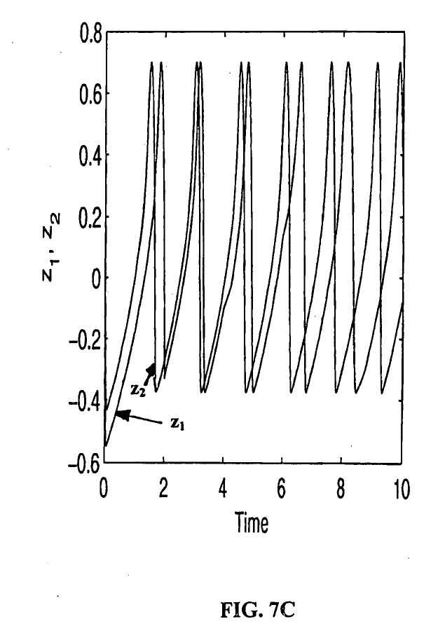

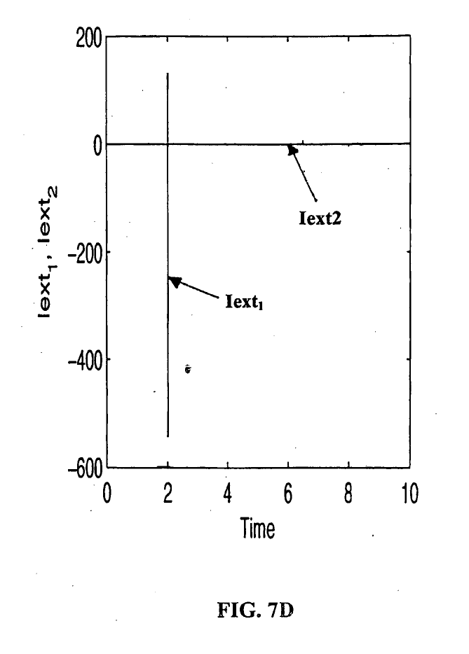

Simulation results are now presented for the closed-loop system of Equations (5) and (35). The parameter values, command input sequence, and the initial conditions of FIG. 1(A)-(D) are retained. The feedback gains are chosen are so that the poles of the e-dynamics are at (−7.07±j7.072). Simulated responses are shown in FIG. 6(A)-(D) and FIG. 7(A)-(D). Synchronization is accomplished and the (z and w)-responses are smoother and control input is smaller than those obtained using the control laws, Cᵤ and Cᵥ. However, sharper peaking of u- and w-response is observable at certain instances, when the phase command changes. However, the stability results have been established only for the local synchronization.

### Local Synchronization: Control Law (C_{w})

A still simpler control law for the choice of the controlled output variable is:

e(t)=w₁(t)−w₂(t−t_{d})=\tilde{w}=h_{w}(xₐ(t)). (43)

For this choice, one has

ė(t)=L_{f}h_{w}(xₐ(t))+L_{g}h_{w}(xₐ(t))u_{c1}(t) (44)

and the control law is

u_{c1}=\tilde{z}(t)+p₀ ε_{Ca}⁻¹ \tilde{w} (45)

where pₒ is any positive number. Thus the control law has simple linear feedback terms involving only the \tilde{z} and \tilde{w} variables and are independent of uᵢ and vᵢ.

The output \tilde{w} now satisfies a first-order equation

{tilde over (\dot{w}+p₀\tilde{w}=0 (46)

and in the closed-loop system \tilde{w} tends to zero. However, the stability in the closed-loop system will depend on the stability property of the zero dynamics which is now of dimension three.

The zero dynamics in this case are obtained by setting \tilde{w}=0 and can be shown to be described by

$$\begin{matrix}[ \begin{matrix}\dot{\tilde{u}} \\ \dot{\tilde{v}} \\ \tilde{z}\end{matrix} ] = [ \begin{matrix}- ak {∈}_{Na}^{- 1} & - k {∈}_{Na}^{- 1} & 0 \\ k & 0 & - k \\ 0 & 0 & - a\end{matrix} ] [ \begin{matrix}\tilde{u} \\ \tilde{v} \\ \tilde{z}\end{matrix} ] + [ \begin{matrix}{g}_{u} ( \tilde{u} , t ) \\ 0 \\ {g}_{z} ( \tilde{z} , t )\end{matrix} ] \dot{=} {{A}_{w} ( \tilde{u} , \tilde{v} , \tilde{z} )}^{T} + {g}_{uz} ( \tilde{u} , \tilde{z} , t ) \\ where {g}_{uz} ( \tilde{u} , \tilde{z} , t ) = {( {g}_{u} , 0 , {g}_{z} )}^{T} and & ( 47 ) \\ {g}_{z} - ( 1 + a - 3 {z}_{2} ( t - {t}_{d} ) ) {\tilde{z}}^{2} + ( 2 ( 1 + a ) {z}_{2} ( t - {t}_{d} ) - 3 {z}_{2}^{2} ( t - {t}_{d} ) ) \tilde{z} - {\tilde{z}}^{3} . & ( 48 )\end{matrix}$$

Apparently if the origin (ũ, \tilde{v}, \tilde{z})=0 of the zero dynamics is asymptotically stable, then \tilde{x} converges to zero as \tilde{w} tends to zero.

In Equation (47), the matrix A_{w} is Hurwitz and the periodic signals u₂(t−t_{d}) and z₂(t−t_{d}) are functions of the state xₑ of the exosystem. In this case, in view of the functions gᵤ and g_{z} in Equation (47), one finds that the center manifold is (ũ,\tilde{v},\tilde{z})=(Ũ,\tilde{V},\tilde{Z})=0. Similar to the arguments used on either the Jacobian linearization or the center manifold theorem, it can be concluded that for small (u₂(t−t_{d}),z₂(t−t_{d})), the origin of the zero dynamics is exponentially stable (in a local sense), and thereby local synchronization is accomplished.

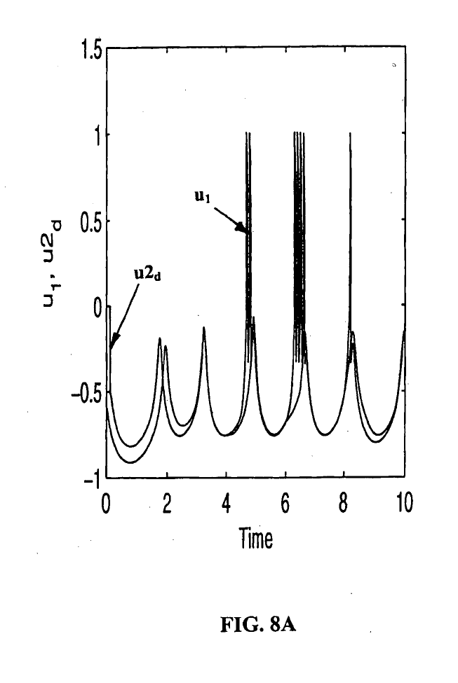

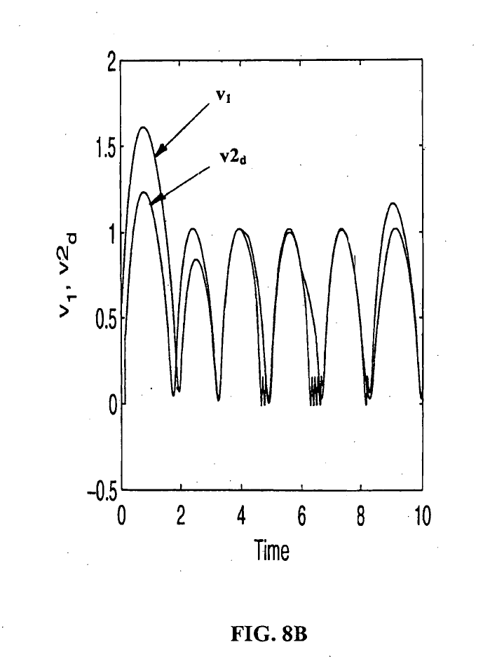

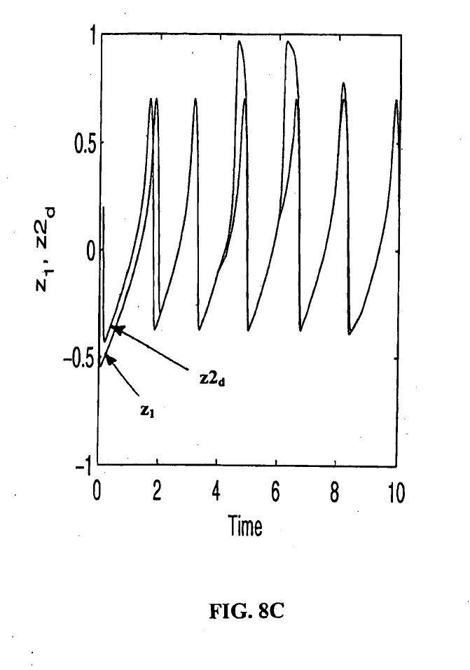

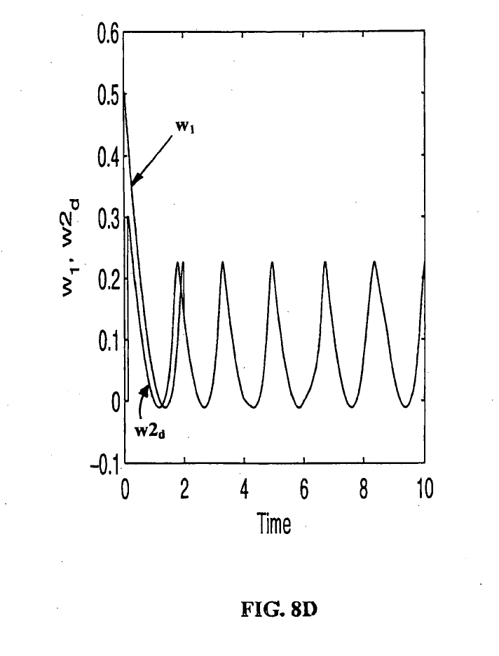

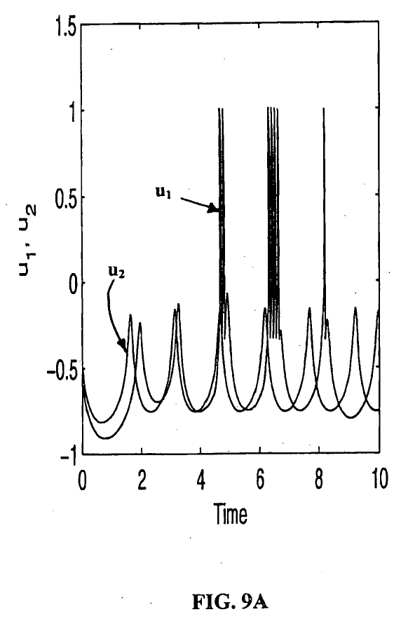

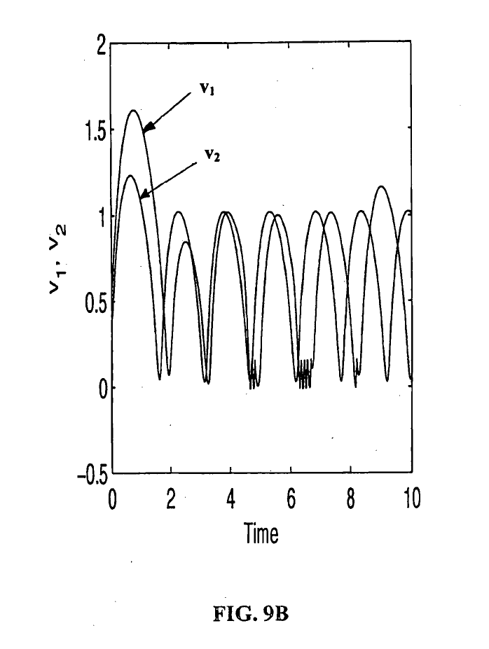

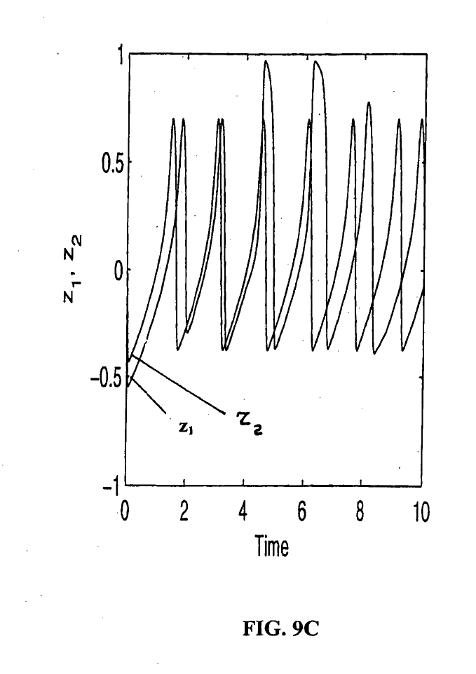

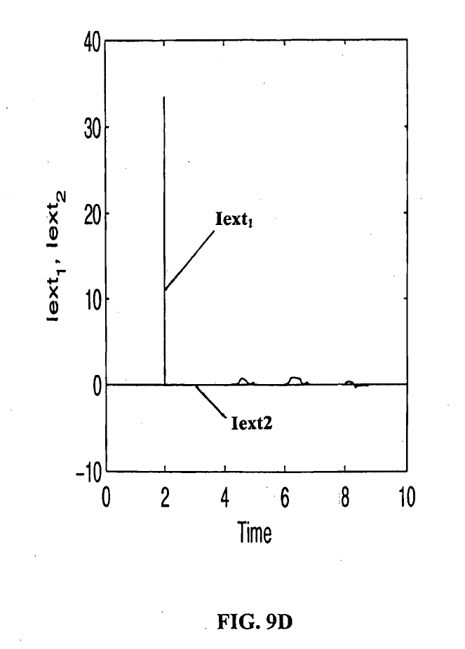

Simulation results are now presented for the closed-loop system of Equation (5) and Equation (45). The parameter values, command input sequence, and the initial conditions of FIG. 1(A)-(D) are retained. The feedback gain chosen is p₀=8. The responses are shown in FIG. 8(A)-(D) and FIG. 9(A)-(D). It is observed that synchronization has been accomplished following each change in the phase command signal, but convergence time is larger. The plots of u₁ show high frequency oscillation at certain instances, but it has not caused any problems. Only a small control magnitude has been used.

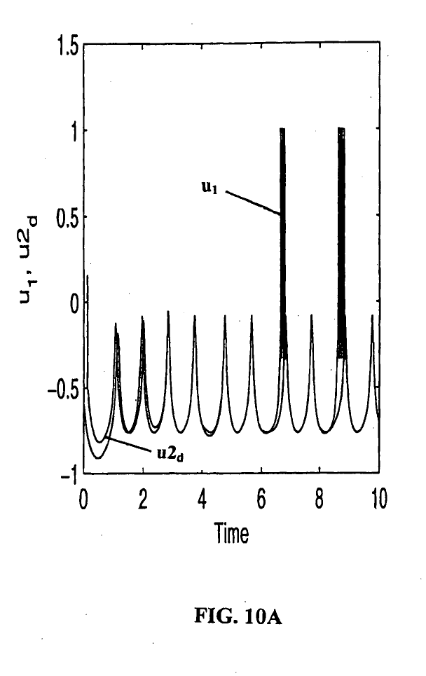

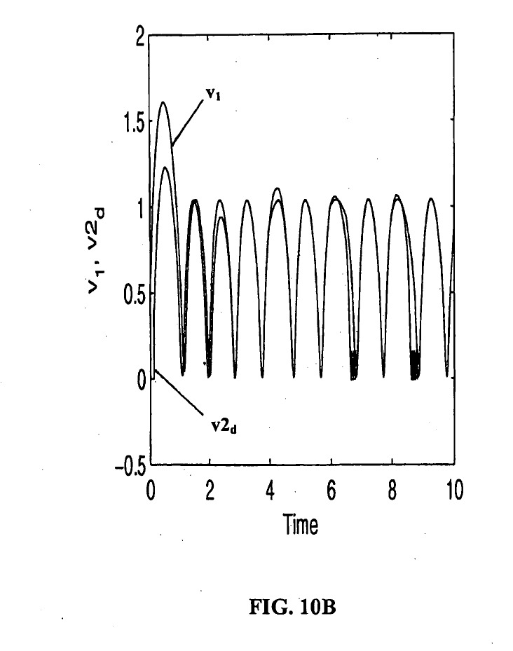

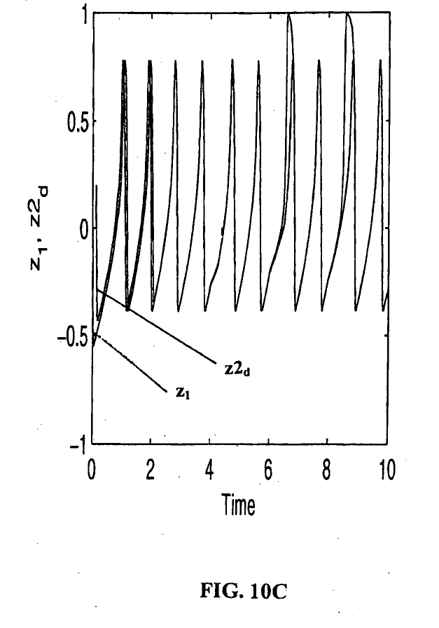

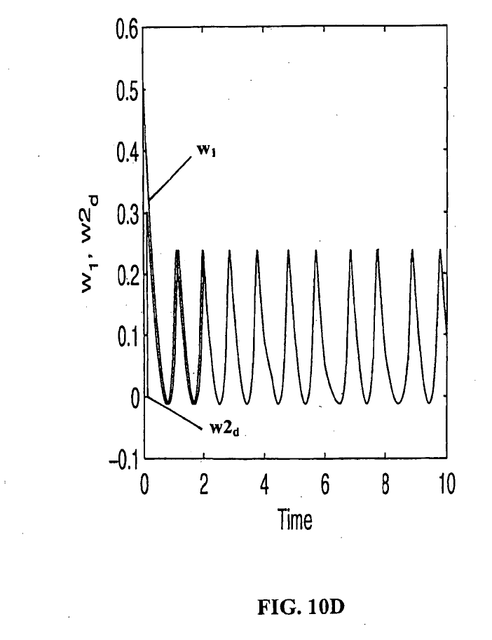

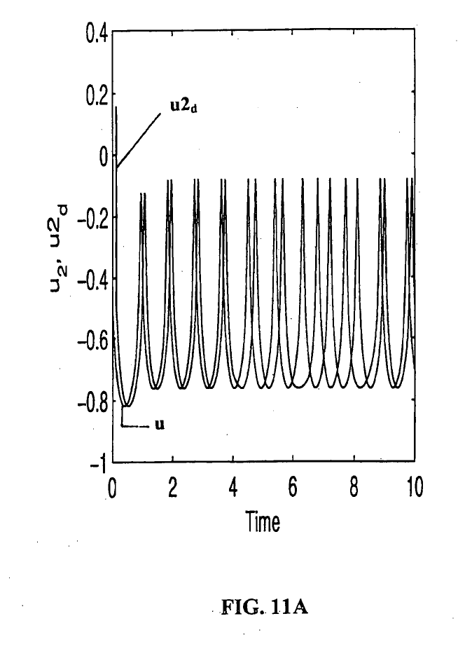

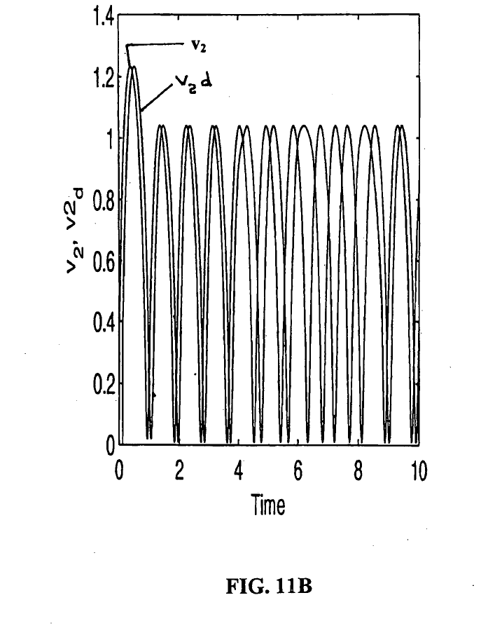

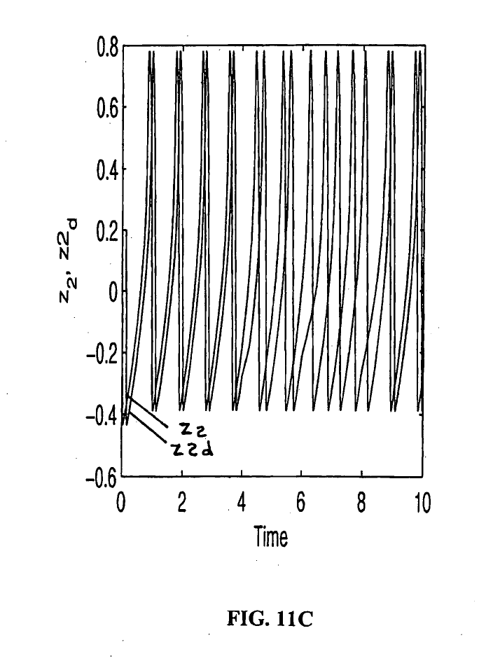

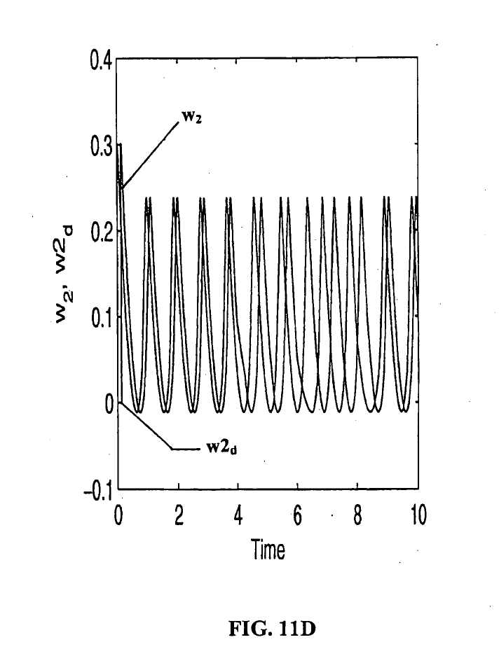

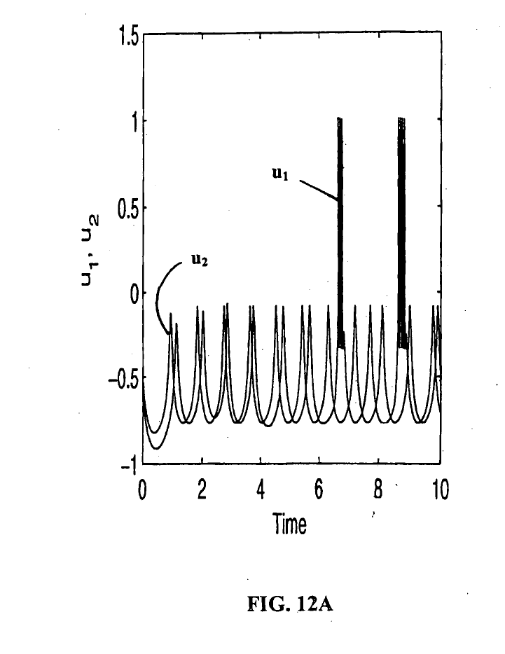

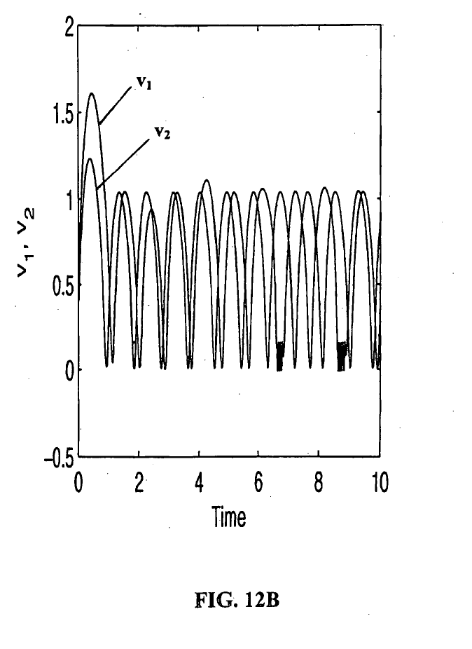

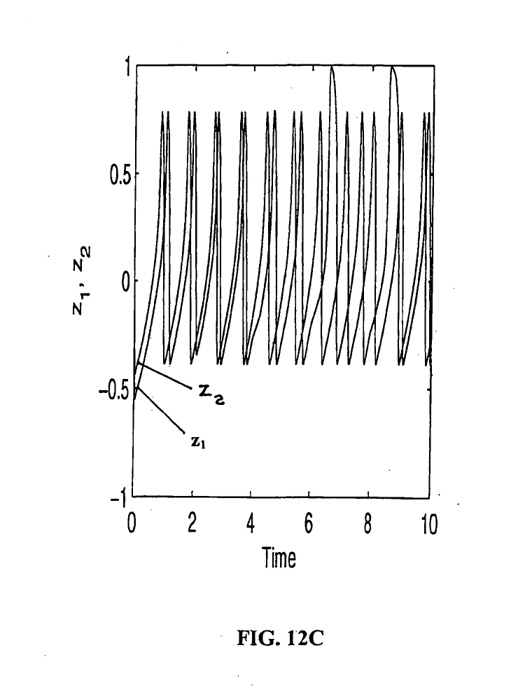

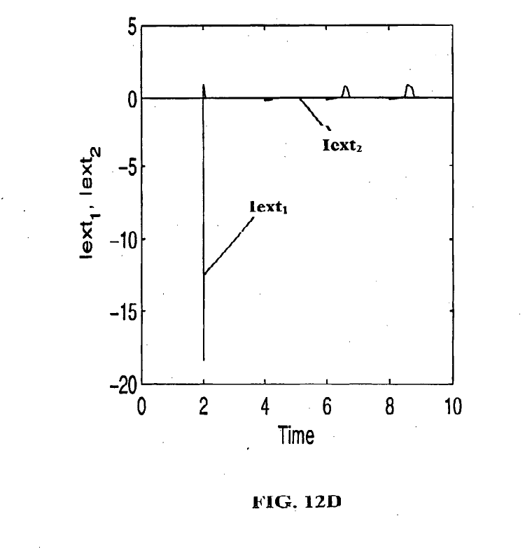

Simulation results are obtained for a different value of the parameter a=0.01 and the time scaling factor is set to 100 giving the frequency of oscillation close to one Hz. The closed-loop control system using each of the control laws Cᵤ, Cᵥ and C_{z} and C_{w} is simulated. The command input, the feedback gains, and initial conditions of FIG. 1(A)-(D) are retained for simulation. Results are presented only for the closed-loop system including the simplest control law C_{w}. The responses are shown in FIG. 10(A)-(D) through FIG. 12(A)-(D).

It is of interest to discuss the relative merits of the four controllers. As indicated earlier, the first controller has a global stabilization property and for the remaining controllers only local synchronization has been established. It is important to note that only a finite region of stability in the \tilde{x}-space exists because the local stability of the closed-loop system including the controllers Cᵥ, C_{z}, and C_{w} has been proven. But it is expected that as the complexity of control law increases, the region of stability enlarges. For this reason, one expects that the control law C_{w} has been proven. But it is expected that as the complexity of control law increases, the region of stability enlarges. For this reason, one expects that the control law C_{w} can accomplish synchronization only for relatively small perturbations in \tilde{x} at the instant when the phase command is given. Of course, the error \tilde{x}, and therefore the synchronization of the IOs, depends on the instant of controller switching. Based on the simulation results, it has been found that the controllers Cᵥ and C_{z} have fairly large regions of stability and one does not necessarily have to use the controller Cᵤ, which has the highest degree of complexity among the derived controllers. Unlike the global controller, the controllers Cᵥ, C_{z}, and C_{w} provide smoother (z,w)-responses. This is due to the fast-varying nonlinear function of large magnitude in the control law Cᵤ. It may be pointed out that there exists flexibility in the design, and by a proper choice of feedback gains and the reference phase command signals, one can obtain different response characteristics. This flexibility in phase control of IOs is useful in performing desirable maneuvers of the BAUV.

In the derivation of the control laws, it is assumed that the IOs are identical. While for the BAUV application, it is appropriate to have similar parameters, it is pointed out that the design approach is quite general, and it is applicable to nonidentical IOs having different parameters. The design has been presented only for two IOs, but it is straightforward to extend the derivation for the synchronization of any number of IOs.

### Advantages and Disadvantages

The IOs have complex nonlinear dynamics. As such, controllers (PID, optimal, lead-lag compensation, etc.) designed using linearized models cannot guarantee global synchronization. One must note that the profile of the control signal will depend on the states of the IOs when the pulse is applied. The derived controllers are based on the input-output feedback linearization theory, and stability and convergence. The designed global controller accomplishes synchronization for all initial conditions. Moreover, design parameters provide flexibility in shaping response characteristics. The controller can be switched on for phase control at any instant since the controller utilizes state variable feedback and one can command the IO to follow a sequence of phase changed when needed for the control of the BAUV. This is especially important if operating fins of the BAUV operate at low frequencies. The control laws are explicit functions of the state variables of the IOs and can be easily implemented.

The foregoing description of the preferred embodiments of the invention has been presented for purposes of illustration and description only. It is not intended to be exhaustive nor to limit the invention to the precise form disclosed; and obviously many modifications and variations are possible in light of the above teaching. Such modifications and variations that may be apparent to a person skilled in the art are intended to be included within the scope of this invention as defined by the accompanying claims.

What is claimed is:

1. A control system for maneuvering an underwater vehicle, said control system comprising:
a propulsor system positioned on the underwater vehicle; and
a controller operationally connected to said propulsor wherein said controller is capable recognizing at least two inferior olives such that a first inferior olive of the inferior olives oscillates in synchronism with a predetermined delay time t and a phase angle corresponding to a second inferior olive of the inferior olives to resolve nonlinear functions in response to disturbances when maneuvering;
wherein the inferior olives are controlled by synchronization of initial conditions of the first inferior olive and the second inferior olive such that a controlled output variable is chosen as
e(t)=hᵤ(x₁(t), x₂(t−t_{d}))=u₁(t)−u₂(t−t_{d})
wherein a composite state vector for the inferior olives is defined as xₐ(t)=(x₁(t)^{T}, x₂(t−t_{d})^{T} ε R⁸ and a vector field is defined by
$${L}_{f} {h}_{u} ( {x}_{a} ( t ) ) = \frac{\partial h}{\partial {x}_{a}} f ( {x}_{a} ( t ) ) = \frac{\partial {h}_{u}}{\partial {x}_{1}} {f}_{1} ( {x}_{1} ( t ) ) + \frac{\partial {h}_{u}}{\partial {x}_{2}} {f}_{2} ( {x}_{2} ( t - {t}_{d} ) ) ;$$
$$resolving {L}_{f}^{i} {h}_{u} ( {x}_{a} ) = {L}_{f} {L}_{f}^{j - 1} {h}_{u} ( {x}_{a} ( t ) ) and$$
$${L}_{g} {L}_{f}^{k} {h}_{u} ( {x}_{a} ) = \frac{\partial {L}_{f}^{k} {h}_{u}}{\partial {x}_{a}} g$$
wherein an input-output linearizing control law for the inferior olives programmable to the controller is selected by
$${u}_{c 1} = {b}_{u 1}^{- 1} \text{(} - {a}_{u 1} - {\sum }_{j = 0}^{3} {p}_{j} {L}_{f}^{j} {h}_{u} ( {x}_{a} ( t ) ) .$$

2. A method for maneuvering an underwater vehicle, said method comprising the steps of:
providing at least two inferior olives;
resolving e=h(x₁(t), x₂(t−t_{d}));
choosing an output variable
e(t)=hᵤ(x₁(t), x₂(t−t_{d}))=u₁(t)−u₂(t−t_{d});
defining a composite state vector for the inferior olives as
xₐ(t)=(x₁(t)^{T}, x₂(t−t_{d})^{T} ε R⁸;
defining along a vector field
$${L}_{f} {h}_{u} ( {x}_{a} ( t ) ) = \frac{\partial h}{\partial {x}_{a}} f ( {x}_{a} ( t ) ) = \frac{\partial {h}_{u}}{\partial {x}_{1}} {f}_{1} ( {x}_{1} ( t ) ) + \frac{\partial {h}_{u}}{\partial {x}_{2}} {f}_{2} ( {x}_{2} ( t - {t}_{d} ) ) ;$$
$$resolving {L}_{f}^{i} {h}_{u} ( {x}_{a} ) = {L}_{f} {L}_{f}^{j - 1} {h}_{u} ( {x}_{a} ( t ) ) and$$
$${L}_{g} {L}_{f}^{k} {h}_{u} ( {x}_{a} ) = \frac{\partial {L}_{f}^{k} {h}_{u}}{\partial {x}_{a}} g ;$$
selecting an input-output linearizing control law
$$by {u}_{c 1} = {b}_{u 1}^{- 1} \text{(} - {a}_{u 1} - {\sum }_{j = 0}^{3} {p}_{j} {L}_{f}^{j} {h}_{u} ( {x}_{a} ( t ) ) ;$$
producing an output equation of the form
e⁽⁴⁾+p₃e⁽³⁾+p₂e⁽²⁾+p₁ė+p₀e=0;
synchronizing the inferior olives such that a first inferior olive of the inferior olives oscillates in synchronism with a delay time corresponding to a desired phase angle with respect to a second inferior olive of the inferior olives;
processing the synchronized inferior olives with a controller; and
maneuvering a propulsor of the underwater vehicle with the controller.

3. The method in accordance with claim 2, further comprising the step of obtaining frequencies of the inferior olives by time scaling.

4. A method for controlling an underwater vehicle, said method comprising the steps of:
providing at least two inferior olives;
choosing an output variable for the inferior olives
e(t)=hᵥ(xₐ(t))=v₁(t)−v₂(t−t_{d})=\tilde{v}(t);
selecting an input-output linearizing control law by
$${u}_{c 1} = {b}_{v 1}^{- 1} ( - {a}_{v 1} - {\sum }_{j = 0}^{2} {p}_{j} {L}_{f}^{j} {h}_{v} ( {x}_{a} ( t ) ) ) ;$$
determining an output equation e⁽³⁾+p₂e⁽²⁾+p₁ė+p₀e=0;
choosing gains pᵢ such that a characteristic polynomial is
Πᵥ(λ)=λ³+p₂λ²+p₁λ+p₀;
establishing residual dynamics such that an equilibrium point is asymptotically stable;
achieving local synchronization of the inferior olives such a first inferior olive of the inferior olives oscillates in synchronism with a delay time corresponding to a desired phase angle with respect to a second inferior olive of the inferior olives in a closed system;
processing the synchronized inferior olives with a controller; and
maneuvering a propulsor of the underwater vehicle with the controller.

5. The method in accordance with claim 4, said method further comprising the step of establishing asymptotic stability of the zero dynamics using a center manifold theorem.

6. A method for controlling an underwater vehicle, said method comprising the steps of:
providing at least two inferior olives;
choosing an output variable e(t)=z₁(t)−z₂(t−t_{d})=h_{z}(xₐ);
selecting an input-output linearizing control law by
$${u}_{c 1} = {b}_{z 1}^{- 1} \text{(} - {a}_{z 1} - {\sum }_{j = 0}^{1} {p}_{j} {L}_{f}^{j} {h}_{v} ( {x}_{a} ( t ) ) ;$$
determining an output equation e⁽²⁾+p₁ė+p₀e=0;
choosing gains pᵢ such that a characteristic polynomial is
Π_{z}(λ)=λ²+p₁λ+p₀;
defining a composite state vector for the inferior olives as
xₐ(t)=(x₁(t)^{T}, x₂(t−t_{d})^{T} ε R⁸;
establishing residual dynamics such that an equilibrium point is asymptotically stable;
achieving local synchronization of the inferior olives such a first inferior olive of the inferior olives oscillates in synchronism with a delay time corresponding to a desired phase angle with respect to a second inferior olive of the inferior olives in a closed system;
processing the synchronized inferior olives with a controller; and
maneuvering a propulsor of the underwater vehicle with the controller.

7. A method for controlling an underwater vehicle, said method comprising the steps of:
providing at least two inferior olives;
choosing an output variable
e(t)=w₁(t)−w₂(t−t_{d})=\tilde{w}=h_{w}(xₐ(t));
selecting an input-output control law by u_{c1}=\tilde{z}(t)+p₀ ε_{Ca}⁻¹ \tilde{w} thereby satisfying an output with {tilde over (\dot{w}+p₀\tilde{w}=0 and in a closed-loop system \tilde{w} tends to zero;
establishing residual dynamics such that an equilibrium point is asymptotically stable;
achieving local synchronization of the inferior olives such a first inferior olive of the inferior olives oscillates in synchronism with a delay time corresponding to a desired phase angle with respect to a second inferior olive of the inferior olives in the closed system;
processing the synchronized inferior olives with a controller; and
maneuvering a propulsor of the underwater vehicle with the controller.
